(19) United States
(12) Patent Application Publication
(10) Pub. No.: US 2010/0157818 A1
(43) Pub. Date: Jun. 24, 2010

(54) NETWORK SYSTEM, SERVER, QUALITY DEGRADATION POINT ESTIMATING METHOD, AND PROGRAM

(75) Inventor: Masayoshi Kobayashi, Tokyo (JP)

Correspondence Address: YOUNG & THOMPSON, 209 Madison Street, Suite 500, Alexandria, VA, 22314, US

(73) Assignee: NEC Corporation, Tokyo (JP)

(21) Appl. No.: 11/997,559

(22) PCT Filed: Aug. 30, 2006
(86) PCT No.: PCT/JP2006/317049

§ 371 Date: Feb. 1, 2008

(30) Foreign Application Priority Data
Aug. 31, 2005 (JP) 2005-251789

(51) Int. Cl. H04L 12/26

(52) U.S. Cl. 370/252

(57) ABSTRACT

A network system estimating a point of quality degradation with high accuracy at high speed based on flow quality information and routing information on a large-scale network is provided. A network system causing a communication characteristic collection unit S11 and route information collection unit S12 to collect flow quality information and routing information on a network, respectively, and including a non-degradation link removal processing unit S15 extracting flows each passing through a route of quality degradation based on quality information and routing information on flows each passing through one of sub-networks N1 to N3 constituting a network 100 collected for each of the sub-networks N1 to N3, and a point-of-quality-degradation estimation unit SA14 estimating routes of quality degradation on the network 100 by merging the quality information on the extracted flows on the respective sub-networks N1 to N3 with one another on the entire network 100.

### TECHNICAL FIELD

The present invention relates to a network system and particularly relates to a network system for estimating a point of communication quality degradation.

### BACKGROUND ART

Conventionally, there is proposed a method of estimating a point of quality degradation, the method including collecting quality information on communication flows passing through a communication network and routing information (route information) on the communication network, and estimating a point at which the communication quality degrades in the communication network based on the collected information, so as to identify the point of communication quality degradation if the communication quality of the communication network degrades. The method of estimating a point of quality degradation is described in, for example, “Estimating points of QoS degradation in the network from the aggregation of per-flow quality information”, Institute of Electronics, Information and Communication Engineers (IEICE) technical report TM-2004-107 (Non-Patent Document 1) and Japanese Patent Application Laid-Open No. 2002-271392 entitled “Method of managing voice quality per call in IP network” (Patent Document 1).

Out of the examples of the method of estimating a point of quality degradation, according to the “Estimating points of QoS degradation in the network from the aggregation of per-flow quality information”, IEICE technical report TM-2004-107 (Non-Patent Document 1), quality information on communication flows passing through a network and routing information on the network are collected from terminals, a flow quality-to-routing link table in which a quality of each of the communication flows is made to correspond to routing links (routes) through which the communication flow passes is created, and a point of quality degradation is estimated using a minimum-links estimation method. The method of estimating a point of quality degradation in a network will now be described while referring to an example.

FIG. 46 is a network configuration diagram. As shown in FIG. 46, routers (or switches) R1-1 to R16 are arranged in a network, terminals T1-1 to T1-23 are provided under the routers (or switches) to be connected to the routers (or switches), and a point-of-quality-degradation estimation server SA1 is connected to the router (or switch) R1-1. The point-of-quality-degradation estimation server SA1 estimates a point of quality degradation in the network based on quality information on each of communication flows collected from the terminals T1-1 to T1-23 and route information obtained from the routers or switches. The “link” means a link between the routers (or switches) or a link between the router (or switch) and the terminal, and is assumed as a link (directed link) holding a one-way communication. FIG. 47 shows an example of names of directed links (links L1-1 to L1-86) in the network configuration diagram of FIG. 46.

An instance in which flows F1 to F11 shown in FIG. 48 are present in the network shown in FIG. 46 will be described.

In this instance, if it is assumed that qualities of the flows F2, F5, F6, F9, F10, and F11 degrade and that those of the other flows (F1, F3, F4, F7, and F8) do not degrade, a flow quality-to-routing link table as shown in FIG. 49 is created. For example, the flow F1 passes through the links L1-1, L1-28, L1-56, L1-62, L1-63, and L1-86. Due to this, in a row of the flow F1 in the flow quality-to-routing link table shown in FIG. 49, a value 1 is written in each of columns of the routing links 1-1, 1-28, 1-56, 1-62, 1-63, and 1-86 corresponding to the links through which the flow F1 passes, a value 0 is written in each of the other columns, and a value 0 is written in a quality flag of the flow F1 because of no degradation in the quality of the flow F1. It is to be noted that routing link columns through which the flows F1 to F11 do not pass are deleted from the table shown in FIG. 49 in advance for the convenience sake.

Next, it is assumed that qualities of the routing links through which the flows, for which the value 0 is set to their respective quality flags in the flow quality-to-routing link table, pass do not degrade. If a processing (non-degradation link removal processing) for removing the columns of these routing links and the rows of the flows the qualities of which do not degrade from the flow quality-to-routing link table shown in FIG. 49 is performed, the table of FIG. 49 is changed to a flow quality-to-routing link table shown in FIG. 50. Among the routing links described in the flow quality-to-routing link table shown in FIG. 50, if a link set constituted by a sum of sets of routing links through which the respective flows pass is assumed, minimum links of the number of routing links constituting the link set any one of which each of the flows always passes through are estimated as points of degradation. For example, in case of the table shown in FIG. 50, the flows F5 and F6 pass through {L1-17}, the flows F2 and F9 pass through {L1-52}, and the flows F10 and F11 pass through {L1-59}. Due to this, any one of the flows F2, F5, F6, F9, F10, and F11 always passes through one of the routing links, and a minimum value of the number of routing links by which the flows F2, F5, F6, F9, F10, and F11 pass through the links is three. As a result, the three links {L1-17, L1-59} are estimated as points of degradation in the network.

Patent Document 1: Japanese Patent Application Laid-Open No. 2002-271392

Non-Patent Document 1: “Estimating points of QoS degradation in the network from the aggregation of per-flow quality information”, Institute of Electronics, Information and Communication Engineers (IEICE) technical report TM-2004-107

### DISCLOSURE OF THE INVENTION

### Problems to be Solved by the Invention

However, the following problems occur if this conventional method is applied to a large-scale network.

First, many links are included in the large-scale network. Due to this, it requires many communication flows to estimate points of quality degradation. As a result, load for collecting quality information on the flows disadvantageously increases, which disadvantageously makes processing time for a processing of estimating points of quality degradation long.

Moreover, since many links are included in the large-scale network, load for collecting topology information disadvantageously increases, which disadvantageously makes processing time for a processing of estimating points of quality degradation long.

Furthermore, in case of the large-scale network, the number of links included in the network is quite large and the collected quality information on the flows is quite large in amount. As a result, a flow-to-link table showing the relationship between the quality of each flow and the links through which the flow passes becomes disadvantageously and extremely large, which disadvantageously makes processing time for a processing of estimating points of quality degradation long.

It is an object of the present invention to provide a network system, a server, a method of estimating a point of quality degradation, and a program capable of solving the problems of the conventional techniques and estimating a point of quality degradation at high speed with high accuracy in a large scale network based on flow quality information and routing information.

### Means for Solving the Problems

To attain the object, the present invention provides a network system collecting quality information and routing information on flows on a network, comprising: means for extracting flows each passing through a route of quality degradation based on quality information and routing information on flows each passing through one of a plurality of sub-networks constituting the network collected for each of the sub-networks constituting the network; and means for estimating routes of quality degradation on the network by merging the quality information on the extracted flows on the respective sub-networks with one another on the entire network.

To attain the object, according to the present invention, a route is defined as a route of no quality degradation even if a flow of quality degradation passes through the route as long as a flow of no quality degradation passes through the route, internal flows each passing through only one of the sub-networks and external flows each passing through the plurality of sub-networks are extracted from the flows each passing through the route of quality degradation, a sum of a set of routes estimated as routes of quality degradation for non-common internal flows that are included in the internal flows and that do not share routes with the external flows and the internal flows sharing at least one route with the external flows, and a set of routes estimated as the routes of quality degradation based on internal flows other than the non-common internal flows included in the internal flows and on the external flows are estimated as the routes of quality degradation on the network.

To attain the object, according to the present invention, a route is defined as a route of no quality degradation even if a flow of quality degradation passes through the route as long as a flow of no quality degradation passes through the route, internal flows each passing through only one of the sub-networks are extracted from the flows each passing through the route of quality degradation, a first route of quality degradation is estimated for the internal flows, external flows each passing through the route of quality degradation and not passing through the first route on each of the sub-networks through which each of the external flows passes are extracted from the external flows each passing through the plurality of sub-networks, the quality information on the external flows is merged on the entire network for each of the flows identified based on the routing information, a second route of quality degradation is estimated for the external flows based on the quality information on the merging-processed external flows, and the route of quality degradation on the network is estimated by a sum of sets of the first route and the second route.

To attain the object, according to the present invention, a route is defined as a route of no quality degradation even if a flow of quality degradation passes through the route as long as a flow of no quality degradation passes through the route, internal flows each passing through only one of the sub-networks are extracted from the flows each passing through the route of quality degradation, a first route of quality degradation is estimated for the internal flows, a first external flow passing through the route of quality degradation and not passing through the first route on each of the sub-networks through which each of the external flows passes is extracted from the external flows each passing through the plurality of sub-networks, the quality information on the first external flows is merged on the entire network for each of the flows identified based on the routing information, a second route of quality degradation is estimated for the first external flows based on the quality information on the merging-processed external flows, a second external flow passing through the route of quality degradation and passing through at least the first route on each of the sub-networks through which each of the external flows passes through is extracted from the external flows each passing through the plurality of sub-networks, a third route of quality degradation is estimated based on information on the second external flows and information on the internal flows on one of the sub-networks including the second external flow for the external flows including the first external flow and the second external flow on different sub-networks, and the route of quality degradation on the network is estimated by a sum of sets of the first route, the second route, and the third route.

With these constitutions, the point-of-quality-degradation estimation processing according to the present invention divides the entire network into sub-networks and each of the sub-networks collects flow quality information on the flows passing through each sub-network and routing information, thereby making it possible to distribute collection load in relation to network information and to perform parallel processing.

Furthermore, with these constitutions, the point-of-quality-degradation estimation processing according to the present invention enables the processing for extracting flows each passing through the route of quality degradation to be distributed to the respective sub-networks and enables the respective sub-networks to perform the processing in parallel.

According to the present invention, the entire network is divided into sub-networks and each of the sub-networks collects flow quality information on the flows passing through each sub-network and routing information, thereby making it possible to distribute collection load in relation to network information and to perform parallel processing. It is, therefore, possible to reduce processing time required for a flow quality processing.

Furthermore, according to the present invention, even a processing for extracting flows passing through routes of quality degradation can be distributed to the respective sub-networks and performed in parallel. It is, therefore, possible to reduce processing time required for a processing of estimating points of quality degradation.

### BRIEF DESCRIPTION OF THE DRAWINGS

FIG. 1 is a configuration diagram of a network according to a first embodiment of the present invention;

FIG. 2 is an internal configuration diagram of a sub-network point-of-quality-degradation estimation server according to the first embodiment;

FIG. 3 is an explanatory diagram of directed links in the configuration diagram of the network according to the first embodiment;

FIG. 4 shows an example of flows according to the first embodiment;

FIG. 5 is a flow quality-to-routing link table of a sub-network N1 according to the first embodiment;

FIG. 6 is a flow quality-to-routing link table of a sub-network N2 according to the first embodiment;

FIG. 7 is a flow quality-to-routing link table of a sub-network N3 according to the first embodiment;

FIG. 8 is a flow quality-to-routing link table of the sub-network N1 after a non-degradation link removal processing according to the first embodiment;

FIG. 9 is a flow quality-to-routing link table of the sub-network N2 after a non-degradation link removal processing according to the first embodiment;

FIG. 10 is a flow quality-to-routing link table of the sub-network N3 after a non-degradation link removal processing according to the first embodiment;

FIG. 11 is a block diagram showing a hardware configuration of a sub-network point-of-quality-degradation estimation server S1 according to the first embodiment;

FIG. 12 is an internal configuration diagram of an entire network point-of-quality-degradation estimation server according to the first embodiment;

FIG. 13 is a merging-processed flow quality-to-routing link table according to the first embodiment;

FIG. 14 is a flowchart showing operation performed by the sub-network point-of-quality-degradation estimation server S1 according to the first embodiment;

FIG. 15 is a flowchart for explaining a processing performed by a non-degradation link removal processing unit S15 according to the first embodiment in detail;

FIG. 16 is a flowchart showing operation performed by the entire network point-of-quality-degradation estimation server SA1 according to the first embodiment;

FIG. 17 is a flowchart for explaining a processing performed by a table processing unit SA12 according to the first embodiment in detail;

FIG. 18 is an internal configuration diagram of a sub-network point-of-quality-degradation estimation server according to a second embodiment of the present invention;

FIG. 19 is an internal configuration diagram of an entire network point-of-quality-degradation estimation server according to the second embodiment;

FIG. 20 is a flowchart showing operation performed by a sub-network point-of-quality-degradation estimation server S1 according to the second embodiment;

FIG. 21 is a flowchart for explaining a processing (local block extraction processing) performed by a point-of-partial-quality-degradation estimation unit S17 according to the second embodiment in detail;

FIG. 22 is a flowchart for explaining the local block extraction processing according to the second embodiment in more detail;

FIGS. 23A and 23B depict a flowchart showing operation performed by the entire network point-of-quality-degradation estimation server SA1 according to the second embodiment;

FIG. 24 shows an example of flows for explaining the second embodiment;

FIG. 25 is a flow quality-to-routing link table of a sub-network N1 according to the second embodiment;

FIG. 26 is a flow quality-to-routing link table of a sub-network N2 according to the second embodiment;

FIG. 27 is a flow quality-to-routing link table of a sub-network N3 according to the second embodiment;

FIG. 28 is a flow quality-to-routing link table of the sub-network N1 after the local block extraction processing according to the second embodiment;

FIG. 29 is a flow quality-to-routing link table of the sub-network N2 after the local block extraction processing according to the second embodiment;

FIG. 30 is a flow quality-to-routing link table of the sub-network N3 after the local block extraction processing according to the second embodiment;

FIG. 31 is a merging-processed flow quality-to-routing link table in relation to an external block according to the second embodiment;

FIG. 32 is a flow quality-to-routing link table after non-degradation link removal according to a conventional method;

FIG. 33 is a flowchart showing operation performed by the sub-network point-of-quality-degradation estimation server S1 according to a third embodiment of the present invention;

FIG. 34 is a flowchart for explaining a processing (an internal flow restricted estimation processing) performed by a point-of-partial-quality-degradation estimation unit S17 according to the third embodiment in detail;

FIG. 35 is a flowchart showing operation performed by the entire network point-of-quality-degradation estimation server SA1 according to the third embodiment;

FIG. 36 is a flow quality-to-routing link table of the sub-network N1 after the internal flow restricted estimation processing according to the third embodiment;

FIG. 37 is a flow quality-to-routing link table of the sub-network N2 after the internal flow restricted estimation processing according to the third embodiment;

FIG. 38 is a flow quality-to-routing link table of the sub-network N3 after the internal flow restricted estimation processing according to the third embodiment;

FIG. 39 is a flow quality-to-routing link table after non-degradation link removal according to the conventional method;

FIG. 40 is an internal configuration diagram of a sub-network point-of-quality-degradation estimation server according to a fourth embodiment of the present invention;

FIG. 41 is an internal configuration diagram of an entire network point-of-quality-degradation estimation server according to the fourth embodiment;

FIG. 42 is a flowchart showing operation performed by the sub-network point-of-quality-degradation estimation server S1 according to the fourth embodiment;

FIG. 43 is a flowchart showing operation performed by the entire network point-of-quality-degradation estimation server SA1 according to the fourth embodiment;

FIG. 44 is a flow quality-to-routing link table for explaining a re-estimation processing in the sub-network N2 according to the fourth embodiment;

FIG. 45 is a flow quality-to-routing link table for explaining a re-estimation processing in the sub-network N3 according to the fourth embodiment;

FIG. 46 is a configuration diagram of a network for explaining a conventional technique;

FIG. 47 is an explanatory view of directed links;

FIG. 48 shows an example of flows for explaining the conventional technique;

FIG. 49 is a flow quality-to-routing link table according to the conventional method; and

FIG. 50 is a flow quality-to-routing link table after a non-degradation link removal processing according to the conventional method.

### DESCRIPTION OF REFERENCE NUMERALS

S1: sub-network point-of-quality-degradation estimation server
S11: communication characteristic information collection unit
S12: route information collection unit
S13: partial flow quality-to-routing link table management unit
S14: table storage unit
S15: non-degradation link removal processing unit
S16: server coordination unit
S17: point-of-partial-quality-degradation estimation unit
S18: re-estimation unit
SA1: entire network quality degradation processing server
SA11: server coordination unit
SA12: table processing unit
SA13: table storage unit
SA14: point-of-quality-degradation estimation unit
SA15: display unit
1001: CPU
1002: main storage unit
1003: communication control unit
1004: display unit
1005: input unit
1006: interface unit
1007: auxiliary storage unit
1008: system bus
2000: Internet

### BEST MODE FOR CARRYING OUT THE INVENTION

### First Embodiment

(Explanation of Configuration according to the First Embodiment)

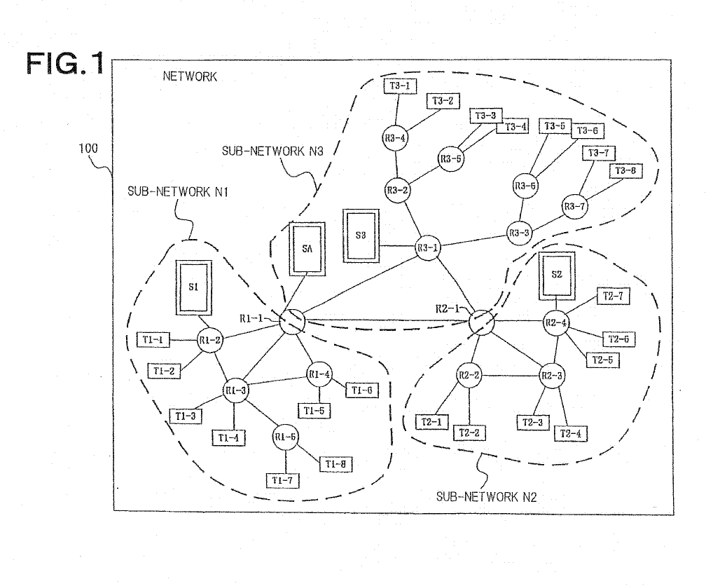

FIG. 1 is a configuration diagram of a network according to a first embodiment of the present invention.

Referring to FIG. 1, a network 100 is configured to include sub-networks N1 to N3 each surrounded by a thick dotted line.

Routers (or switches) R1-1 to R1-5 are arranged in the sub-network N1. Routers (or switches) R2-1 to R2-4 are arranged in the sub-network N2, Routers (or switches) R3-1 to R3-7 are arranged in the sub-network N3. Further, by connecting the router (or switch) R3-1 to the routers (or switches) R1-1 and R2-1, the sub-network N3 is connected to the sub-networks N1 and N2, thus constituting the network 100.

Moreover, in the sub-network N1, the router (or switch) R1-1 is connected to the routers (or switches) R1-2, R1-3, and R1-4, and the router (or switch) R1-3 is connected to the routers (or switches) R1-1, R1-2, R1-4, and R1-5. Further, terminals T1-1 and T1-2 are provided under the router (or switch) R1-2, terminals T1-3 and T1-4 are provided under the router (or switch) R1-3, terminals T1-5 and T1-6 are provided under the router (or switch) R1-4, and terminals T1-7 and T1-8 are provided under the router (or switch) R1-5.

The router (or switch) R1-1 is connected to an entire network point-of-quality-degradation estimation server SA1, and the router (or switch) R1-2 is connected to a sub-network point-of-quality-degradation estimation server S1.

Furthermore, in the sub-network N2, the router (or switch) R2-1 is connected to the routers (or switches) R2-2, R2-3, and R2-4, and the router (or switch) R2-3 is connected to the routers (or switches) R2-1, R2-2, and R2-4. Further, terminals T2-1 and T2-2 are provided under the router (or switch) R2-2, terminals T2-3 and T2-4 are provided under the router (or switch) R2-3, and terminals T2-5 to T2-7 are provided under the router (or switch) R2-4.

The router (or switch) R2-4 is connected to a sub-network point-of-quality-degradation estimation server S2.

Moreover, in the sub-network N3, the router (or switch) R3-1 is connected to the routers (or switches) R3-2 and R3-3, the router (or switch) R3-2 is connected to the routers (or switches) R3-4 and R3-5, and the router (or switch) R3-3 is connected to the routers (or switches) R3-6 and R3-7. Further, terminals T3-1 and T3-2 are provided under the router (or switch) R3-4, terminals T3-3 and T3-4 are provided under the router (or switch) R3-5, terminals T3-5 and T3-6 are provided under the router (or switch) R3-6, and terminals T3-7 and T3-8 are provided under the router (or switch) R3-7.

The router (or switch) R3-1 is connected to a sub-network point-of-quality-degradation estimation server S3.

The terminals T1-1 to T1-8, T2-1 to T2-7, and T3-1 to T3-8 include functions of receiving quality information on each flow (flow quality information) transmitted from a receiving-side terminal on the flow, and notifying the respective sub-network point-of-quality-degradation estimation servers S1 to S3 responsible for processings in the sub-networks to which the groups of terminals belong, of the flow quality information.

The terminals T1-1 to T1-8, T2-1 to T2-7, and T3-1 to T3-8 have knowledge of addresses of the respective sub-network point-of-quality-degradation estimation servers S1 to S3 responsible for processings in the sub-networks to which the groups of terminals belong and are communicable with the servers S1 to S3.

The flow quality information is information about communication quality such as a packet loss rate, burstiness, packet loss burstiness, reception rate, delay, and delay jitter.

The sub-network point-of-quality-degradation estimation servers S1 to S3 are responsible for the processings in the corresponding sub-networks N1 to N3, respectively. Further, the sub-network point-of-quality-degradation estimation servers S1 to S3 receive the flow quality information from the terminals connected to the routers belonging to the respective sub-networks (constituted by links having connections) in which the sub-network point-of-quality-degradation estimation servers S1 to S3 are responsible for the processings in the entire network, assuming that IP addresses of the links belonging to the sub-networks and the routers on both ends of the links, and IP addresses the terminals connected to the routers.

Moreover, the sub-network point-of-quality-degradation estimation servers S1 to S3 have knowledge of addresses of the sub-network point-of-quality-degradation estimation servers S1 to S3 responsible for the processings in the adjacent sub-networks N1 to N3 and the entire-network point-of-quality-degradation estimation server SA1, and are communicable therewith.

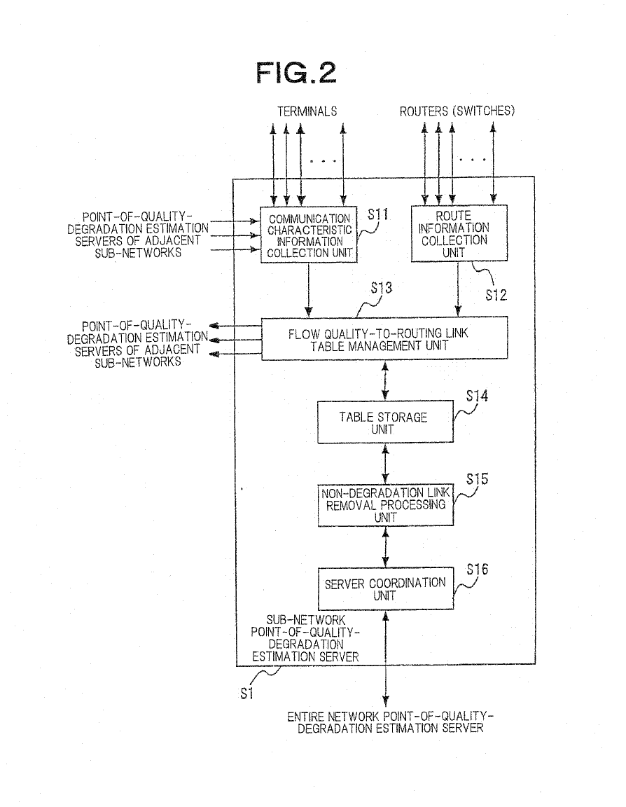

FIG. 2 is an internal configuration diagram of each of the sub-network point-of-quality-degradation estimation servers S1 to S3 according to the first embodiment.

While the sub-network point-of-quality-degradation estimation server S1 will now be explained, the same thing is true for the sub-network point-of-quality-degradation estimation servers S2 and S3.

The sub-network point-of-quality-degradation estimation server S1 is configured to include a communication characteristic information collection unit S11, a route information collection unit S12, a flow quality-to-routing link table management unit S13, a table storage unit S14, a non-degradation link removal processing unit S15, and a server coordination unit S16.

The communication characteristic information collection unit S11 includes a function of receiving communication characteristic information indicating a present communication characteristic from each of the terminals or each of the adjacent sub-network point-of-quality-degradation estimation servers.

The communication characteristic information is configured to include a flow identifier and the flow quality information.

The flow identifier is information that makes each flow identifiable and that is configured to include an address of a flow transmitting-side terminal, an address of a flow receiving-side terminal, a TCP or UDP port number, a protocol identifier, and the like.

Further, the communication characteristic information collection unit S11 receives a communication end notification from a terminal when the terminal ends a communication.

The route information collection unit S12 includes a function of collecting routing-related information (routing link information) from each of the routers (or switches) belonging to the sub-network N1 in which the sub-network point-of-quality-degradation estimation server S1.

To collect the routing-related information (routing link information), the route information collection unit S12 uses, for example, an SMTP (Simple Network Management Protocol).

If the routing-related information is collected, it is possible to decide which route is used for a terminal-to-terminal communication from address information on the terminals.

Specifically, the routing-related information is information extracted from a routing table and an ARP table if the routing-related information is collected from the routers, and is information extracted from a forwarding database and configuration information on a spanning tree if the routing-related information is collected from the switches.

The routing-related information can be given by a network administrator to the route information collection unit S12 without being collected by the route information collection unit S12 from the routers (or switches).

The flow quality-to-routing link table management unit S13 includes a function of creating and managing a flow quality-to-routing link table S131, to be described later, based on the communication characteristic information obtained from the communication characteristic information collection unit S11 and the routing-related information (routing link information) obtained from the route information collection unit S12.

More specifically, the flow quality-to-routing link table management unit S13 includes a function of creating and managing the flow quality-to-routing link table S131 configured to include a flow identifier of each of flows on which communication is currently being held, a set of links through which the flows currently pass, sub-networks (PrevNet) through which the flows previously passed, sub-networks (NextNet) through which the flows are to pass next, and a quality flag indicating whether a current communication quality of each flow is good or bad, based on the communication characteristic information and the routing-related information (routing link information).

Moreover, if a terminal that is a destination of each of the flows does not belong to the sub-network N1 for the processing in which the sub-network point-of-quality degradation estimation server S1 is responsible, the sub-network point-of-quality-degradation estimation server S1 notifies the sub-network point-of-quality-degradation estimation servers S2 and S3 of the adjacent sub-networks N2 and N3 through which the flow passes after the sub-network N1 for the processing in which the sub-network point-of-quality degradation estimation server S1 is responsible, of the communication characteristic information on the flow.

The link is assumed herein a directed link between routers (or switches) or between a router (or switch) and a terminal.

Directed links are provided according to two directions of each flow differently even if the links are between the same routers (or switches) or between the same router (or switch) and the same terminal. For example, between the routers R1-1 and R1-2 in the network configuration diagram of FIG. 1, a flow from the router R1-1 to the router R1-2 and a flow from the router R1-2 to the router R1-1 flow on different directed links (L1-27 and L1-28), respectively.

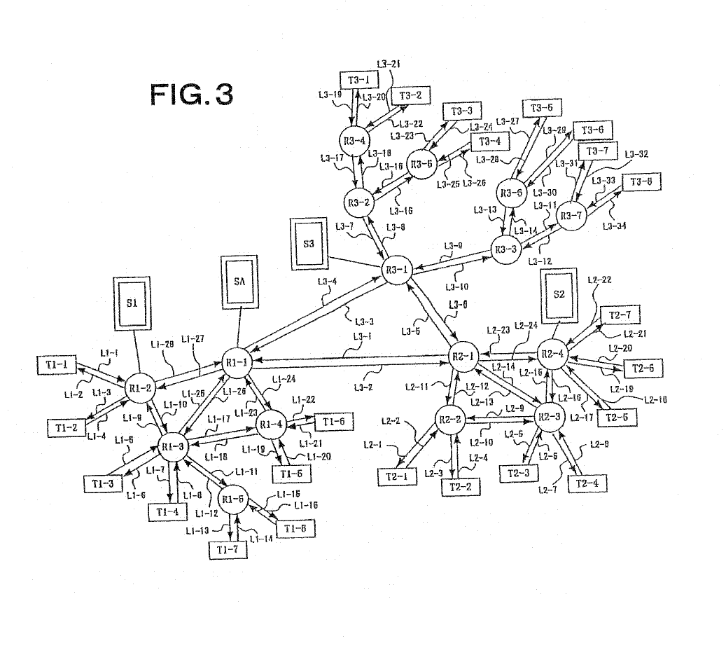

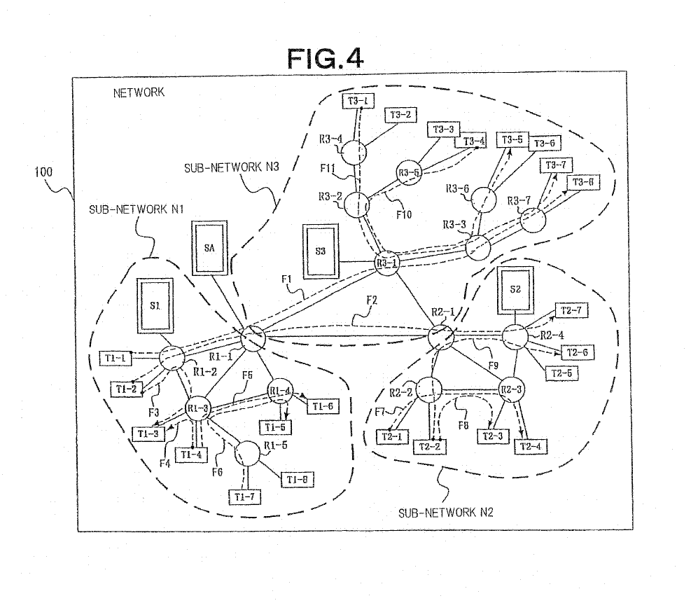

FIG. 3 shows names of the directed links in the network configuration diagram shown in FIG. 1, and FIG. 4 is a diagram showing an example of flows in the network configuration shown in FIG. 1.

How to set a value of a quality flag will first be described.

A flow quality index is obtained from the information (e.g., the packet loss rate, the packet loss burstiness, the reception rate, the delay, and the delay jitter) included in the flow quality information constituting the communication characteristic information. It is determined whether the obtained flow quality index exceeds a degradation threshold indicating whether or not a quality of each flow degrades and given in advance. If the flow quality index is equal to or higher than the degradation threshold as a result of a determination, then it is determined that the quality of the flow degrades and the value of the quality flag of the flow is set to 1.

If the flow quality index is equal to or lower than the degradation threshold given in advance, then it is determined that the quality of the flow does not degrade and the value of the quality flag of the flow is set to 0.

If the determination result does not correspond to both of the above-stated cases, the value of the quality flag is set to uncertain (hereinafter, “N/A”).

As an example of the flow quality index, one of the flow quality information (such as the packet loss rate) can be simply used. If the flow is a VoIP flow, then an R-value can be obtained from the packet loss rate, the delay jitter or the like according to ITU-T recommendation G.107 E-Model and used as the flow quality index.

It is assumed, for example, that flows F1 to F11 are present in the network configuration diagram shown in FIG. 1 as shown in FIG. 4.

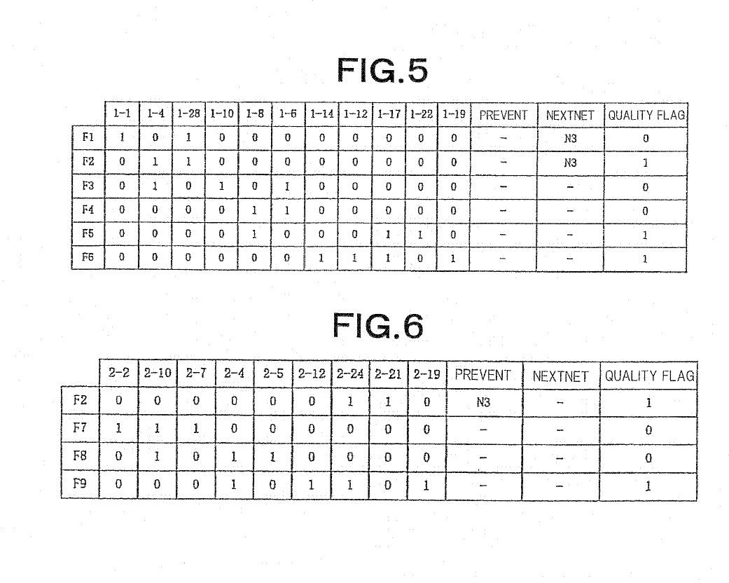

It is assumed that qualities of the flows F2, F5, F6, F9, F10, and F11 degrade and that those of the other flows do not degrade. In this assumption, quality flags of the flows in the flow quality-to-routing link tables S131 of the sub-network point-of-quality-degradation estimation servers S1 to S3 correspond to contents shown in FIGS. 5, 6, and 7, respectively.

Flow identifiers are replaced by flow names F1 to F11 in FIGS. 5, 6, and 7.

The table storage unit S14 stores therein the flow quality-to-routing table S131.

The non-degradation link removal processing unit S15 has the following functions. The non-degradation link removal processing unit S15 reads flow quality information, routing link information and the like from the flow quality-to-routing table S131 stored in the table storage unit S14. If flows the quality flag of each of which has a value 1 are present, the non-degradation link removal processing unit S15 performs a processing of removing columns of routing links, in each of which the value 1 is set, in rows of the flows the quality flag of each of which is set to 0 and the rows of the flows the flow quality flag of each of which is set to 0. Further, after removing the columns of links, the non-degradation link removal processing unit S15 performs a processing of removing rows of flows the quality flag of each of which is set to 1 and in which rows the value 1 is not set to any columns of the routing links.

For example, if the non-degradation link removal processing unit S15 performs the processing (non-degradation link removal processing) of removing the links on the flow quality-to-routing link table S131 shown in FIG. 5, then a flow quality-to-routing link table S151 shown in FIG. 8 is created, and flow quality information, routing link information and the like extracted from the flow quality-to-routing link table S151 shown in FIG. 8 are output to the server coordination unit S16 as a result.

More specifically, to perform the non-degradation link removal processing on the flow quality-to-routing link table S131 shown in FIG. 5, the non-degradation link removal processing unit S15 removes, first of all, columns of routing links 1-1, 1-4, 1-28, 1-10, 18, and 1-6 in rows of the flows F1, F3, and F4 the quality flag of each of which is set to 0, in which columns at least one cell is set to 1, and the rows of the flows F1, F3, and F4 the quality flag of each of which is set to 0, from the flow quality-to-routing link table S131 shown in FIG. 5.

Next, since the columns of routing links 1-4 and 1-28 are removed, none of the routing link cells are set to 1 in the row of the flow F2 the quality flag of each of which is set to 1. Therefore, the non-degradation link removal processing unit S15 removes the row of the flow F2 from the flow quality-to-routing link table S131 shown in FIG. 5.

In this manner, the non-degradation link removal processing unit S15 performs the non-degradation link removal processing, the flow quality-to-routing link table S151 shown in FIG. 8 is created from the flow quality-to-routing link table S131 shown in FIG. 5, and the flow quality information, the routing link information and the like extracted from the flow quality-to-routing link table S151 shown in FIG. 8 are output to the server coordination unit S16 as a result.

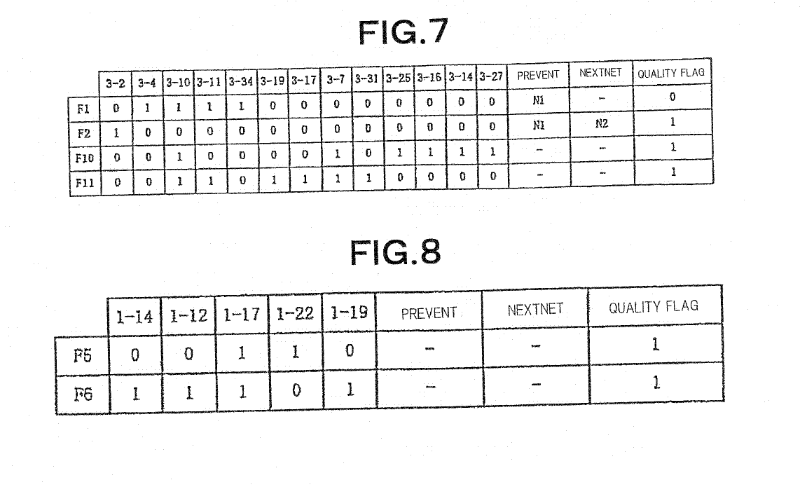

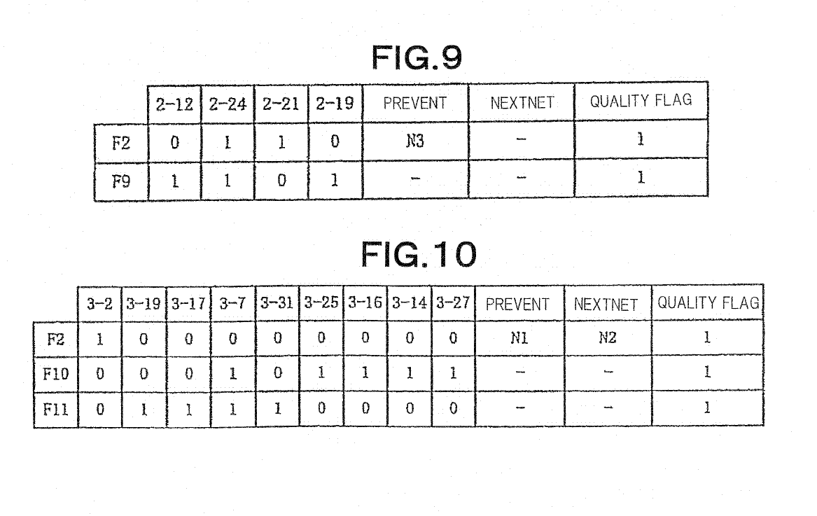

Likewise, if the non-degradation link removal processing unit S15 performs the processing (non-degradation link removal processing) of removing the links on the flow quality-to-routing link tables S131 shown in FIGS. 6 and 7 of the sub-network point-of-quality-degradation estimation servers S2 and S3, then flow quality-to-routing link tables S151 shown in FIGS. 9 and 10 are created, and flow quality information, routing link information and the like extracted from the flow quality-to-routing link tables S151 shown in FIGS. 9 and 10 are output as results, respectively.

The above-stated method is an example of the method for the non-degradation link removal processing and procedures and the like are not limited to the above-stated method.

The server coordination unit S16 includes a function of holding a communication between the sub-network point-of-quality-degradation estimation server S1 and the entire network point-of-quality-degradation processing server SA1. Further, the server coordination unit S16 receives the flow quality information and the routing link information output from the non-degradation link removal processing unit S15, and transmits the received flow quality information and the routing link information to the entire network point-of-quality-degradation processing server SA1.

A hardware configuration of the sub-network point-of-quality-degradation estimation server S1 will now be described.

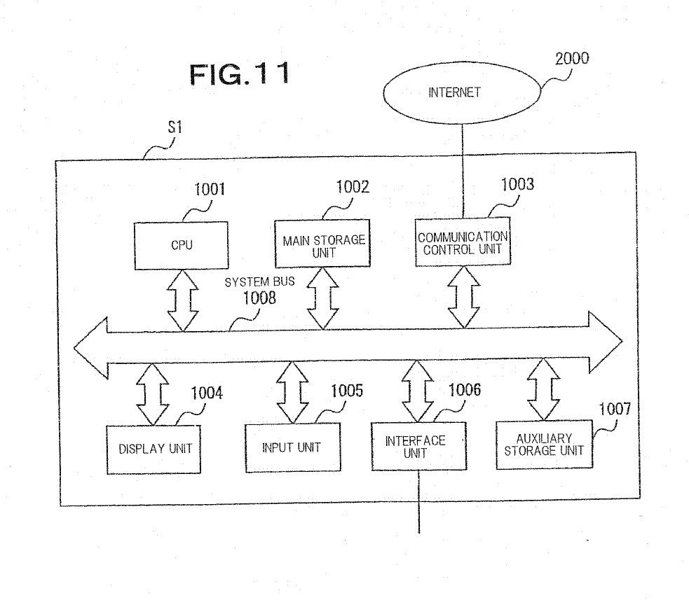

FIG. 11 is a block diagram showing the hardware configuration of the sub-network point-of-quality-degradation estimation server S1 according to the first embodiment.

Referring to FIG. 11, the sub-network point-of-quality-degradation estimation server S1 according to the first embodiment can be realized by a similar hardware configuration to that of an ordinary computer apparatus, and includes a CPU (Central Processing Unit) 1001, a main storage unit 1002, e.g., a RAM (Random Access Memory), that is a main memory and that is used as a data work area or a data temporary save area, a communication control unit 1003 that transmits or receives data via Internet 2000, a presentation unit 1004 such as a liquid crystal display, a printer, and a loudspeaker, an input unit 1005 such as a keyboard and a mouse, an interface unit 1006 that is connected to peripherals and that transmits or receives data to or from the peripherals, an auxiliary storage unit 1007 that is a hard disk device configured to include a nonvolatile memory such as a ROM (Read Only Memory), a magnetic disk or a semiconductor memory, a system bus 1008 that mutually connects the above-stated constituent elements of the information processing apparatus, and the like.

Operation performed by the sub-network point-of-quality-degradation estimation server S1 according to the first embodiment can be realized in a hardware fashion by mounting circuit components including hardware components such as an LSI (Large Scale Integrated) circuit in which a program for realizing such functions is incorporated, in the sub-network point-of-quality-degradation estimation server S1. Besides, the operation performed by the sub-network point-of-quality-degradation estimation server S1 can be realized in a software fashion by executing programs providing the functions of the respective constituent elements on the CPU 1001 on the computer processing apparatus.

Namely, the CPU 1001 realizes the above-stated respective functions in a software fashion by loading the program stored in the auxiliary storage unit 1007 to the main storage unit 1002 and executing the loaded program, and controlling operation performed by the sub-network point-of-quality-degradation estimation server S1.

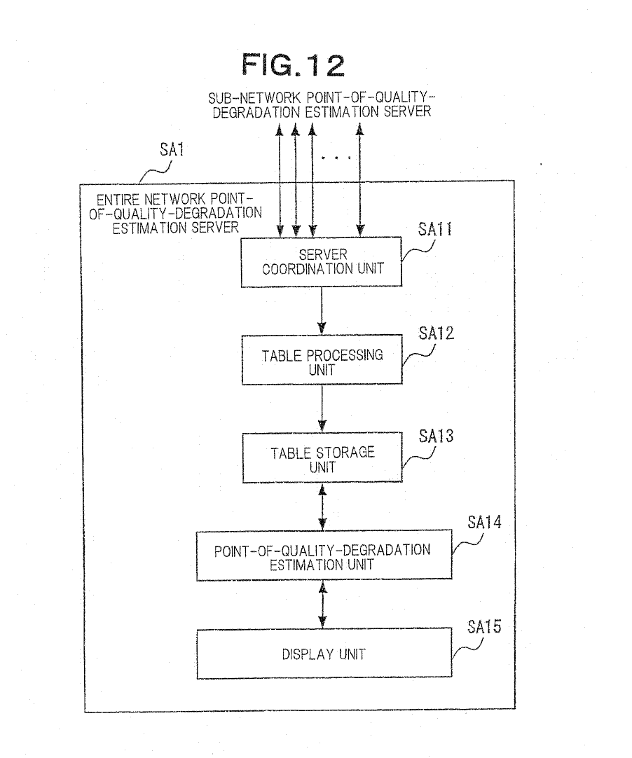

FIG. 12 is an internal configuration diagram of the entire network point-of-quality-degradation estimation server SA1 according to the first embodiment of the present invention.

The entire network point-of-quality-degradation estimation server SA1 is configured to include a server coordination unit SA11, a table processing unit SA12, a table storage unit SA13, a point-of-quality-degradation estimation unit SA14, and a display unit SA15.

The server coordination unit SA11 includes a function of receiving the information extracted from the flow quality-to-routing link tables S151 after the non-degradation link removal processing and transmitted from the respective sub-network point-of-quality-degradation estimation servers S1 to S3, and of transmitting the received information to the table processing unit SA12.

The table processing unit SA12 includes a function of performing a merging processing on the flow quality-to-routing link tables S151 of the sub-networks N1 to N3 based on the information received from the server coordination unit SA11. Further, the table processing unit SA12 includes a function of writing tables created by filling in blank entries of the respective tables each by a value 0 to the table storage unit SA13.

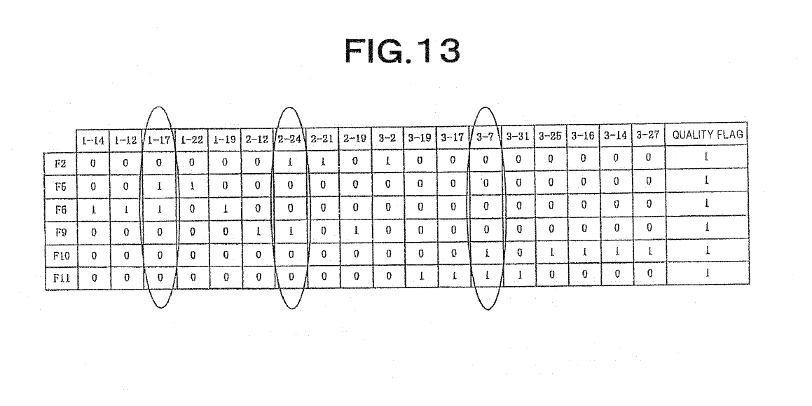

FIG. 13 is a merging-processed flow quality-to-routing link table SA121 created based on each of the flow quality-to-routing link tables S151 shown in FIGS. 8 to 10.

As shown in FIG. 13, if receiving the information extracted from the flow quality-to-routing link tables S151 shown in FIGS. 8 to 10 from the server coordination units S16 of the respective sub-networks N1 to N3, for example, the table processing unit SA12 performs a merging processing on the information and further fills in the blank entries of the tables each by the value 0. The table processing unit SA12 can thereby create the flow quality-to-routing link table SA121.

The merging processing will be described.

In each of the sub-networks N1 to N3, the directed links are uniquely set and the same link number is not, therefore, set repeatedly. Accordingly, the same link number appears on only one sub-network table. Further, the same flow includes the same quality flag.

Due to this, the table processing unit SA12 can organize the same flows in the flow quality-to-routing link tables S151 of the sub-networks N1 to N3 into one row based on values in cells of PrevNet and NextNet in each of the flow quality-to-routing link tables S151 of the sub-networks N1 to N3, and create one table from the respective flow quality-to-routing link tables S151. This is referred to as “merging processing”.

The table storage unit SA13 stores therein the flow quality-to-routing link table SA121 created by the table processing unit SA12.

The point-of-quality-degradation estimation unit SA14 includes functions of reading the flow quality-to-routing link table SA121 from the table storage unit SA13 on regular basis, estimating points of quality degradation, and outputting the estimated points of quality degradation to the display unit SA15.

The display unit SA15, which is, for example, a liquid crystal display, includes a function of displaying the points of quality degradation received from the point-of-quality-degradation estimation unit SA14.

A hardware configuration of the entire network point-of-quality-degradation estimation server SA1 will now be described.

Similarly to the hardware configuration of the sub-network point-of-quality-degradation estimation server S1, the hardware configuration of the entire network point-of-quality-degradation estimation server SA1 according to the first embodiment can be realized by the hardware configuration similar to that of an ordinary computer apparatus. Therefore, the hardware configuration of the entire network point-of-quality-degradation estimation server SA1 will not be described.

Operation performed by the entire network point-of-quality-degradation estimation server SA1 according to the first embodiment can be realized in a hardware fashion by mounting circuit components in which a program for realizing such functions is incorporated, in the entire network point-of-quality-degradation estimation server SA1. Besides, the operation performed by the entire network point-of-quality-degradation estimation server SA1 can be realized in a software fashion by executing programs providing the functions of the respective constituent elements on a CPU on.

Namely, the CPU 1001 realizes the above-stated respective functions in a software fashion by loading the program stored in the auxiliary storage unit 1007 to the main storage unit 1002 and executing the loaded program, and controlling operation performed by the sub-network point-of-quality-degradation estimation server S1.

(Explanation of Operation According to the First Embodiment)

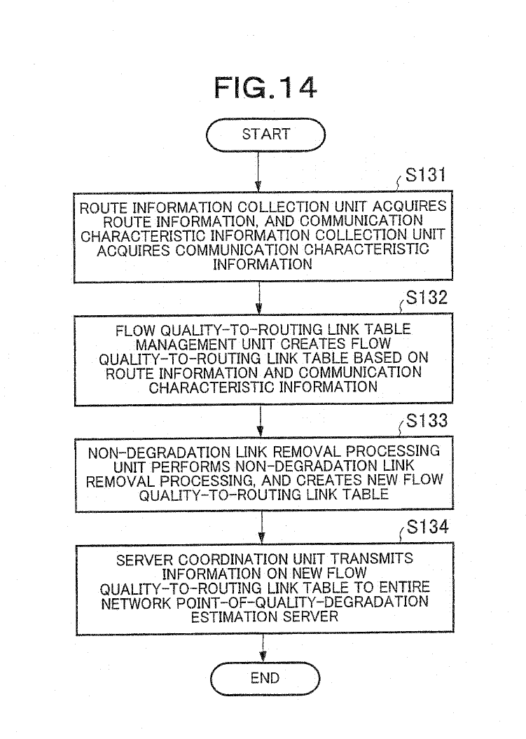

FIG. 14 is a flowchart showing operation performed by the sub-network point-of-quality-degradation estimation server S1.

First, the route information collection unit 12 acquires routing information on a predetermined flow from the routers (or switches) R1-1 to R1-5 arranged in the sub-network N1 for the processing in which the sub-network point-of-quality degradation estimation server S1 is responsible, and the communication characteristic information collection unit S11 acquires communication characteristic information on the predetermined flow from the terminals T1-1 to T1-8 provided under the routers (or switches) R1-1 to R1-5 and from the sub-network point-of-quality-degradation estimation servers S2 and S3 of the adjacent sub-networks N2 and N3 (step S131).

The flow quality-to-routing link table management unit S13 creates the flow quality-to-routing link table SA121 based on the route information and the communication characteristic information acquired at the step S1 (step S132).

The flow quality-to-routing link table management unit S13 transmits information on the flow quality-to-routing link table SA121 created at the step S2 to the sub-network point-of-quality-degradation estimation server S2 and S3 of the adjacent sub-networks N2 and N3. Further, the non-degradation link removal processing S15 performs a non-degradation link removal processing on the flow quality-to-routing link table SA121 created at the step S2, and creates the flow quality-to-routing link table SA151 from the flow quality-to-routing link table SA121 (step S133).

The server coordination unit S16 transmits information on the flow quality-to-routing link table SA151 created at the step S3 to the entire network point-of-quality-degradation estimation server SA1 (step S134).

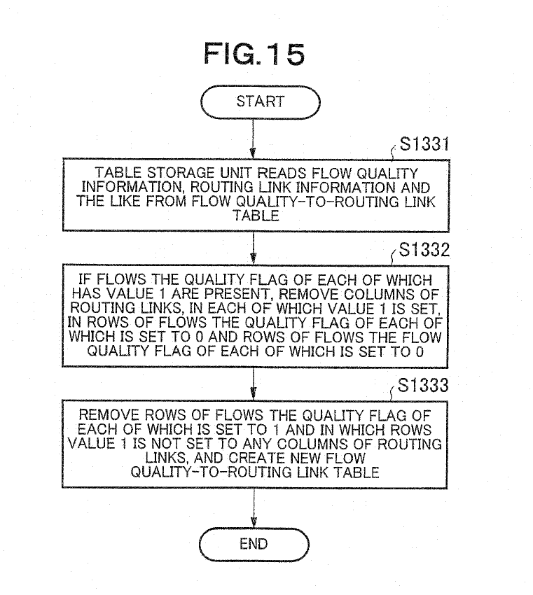

The processing performed by the non-degradation link removal processing unit S15 at the step S133 will be described in more detail with reference to the flowchart of FIG. 15.

The non-degradation link removal processing unit S15 reads the flow quality information, the routing link information and the like from the flow quality-to-routing link table S131 stored in the table storage unit S14 (step S1331). If flows the quality flag of each of which has a value 1 are present, the non-degradation link removal processing unit S15 removes the columns of routing links, in each of which the value 1 is set, in the rows of the flows the quality flag of each of which is set to 0 and the rows of the flows the flow quality flag of each of which is set to 0 (step S1332).

Next, after removing the columns of links at the step S32, the non-degradation link removal processing unit S15 removes the rows of flows the quality flag of each of which is set to 1 and in which rows the value 1 is not set to any columns of the routing links, thereby creating the flow quality-to-routing link table SA151 (step S1333).

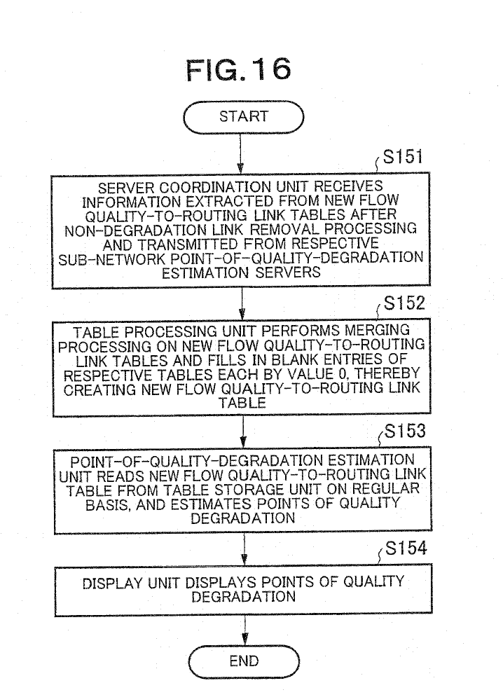

FIG. 16 is a flowchart showing operation performed by the entire network point-of-quality-degradation estimation server SA1.

First, the server coordination unit SA11 receives the information extracted from the flow quality-to-routing link tables S151 after the non-degradation link removal processing and transmitted from the respective sub-network point-of-quality-degradation estimation servers S1 to S3 (step S151).

Next, the table processing unit SA12 performs a merging processing on the flow quality-to-routing link tables S151 of the sub-networks N1 to N3, based on the information received from the server coordination unit SA11. Further, the table processing unit SA12 fills in blank entries of the respective tables each by a value 0, thereby creating the flow quality-to-routing link table SA121 (step S152).

The point-of-quality-degradation estimation unit SA14 reads the flow quality-to-routing link table SA121 from the table storage unit SA13 on regular basis, and estimates points of quality degradation (step S153).

Next, the display unit SA15 displays the points of quality degradation estimated at the step S13 (step S154).

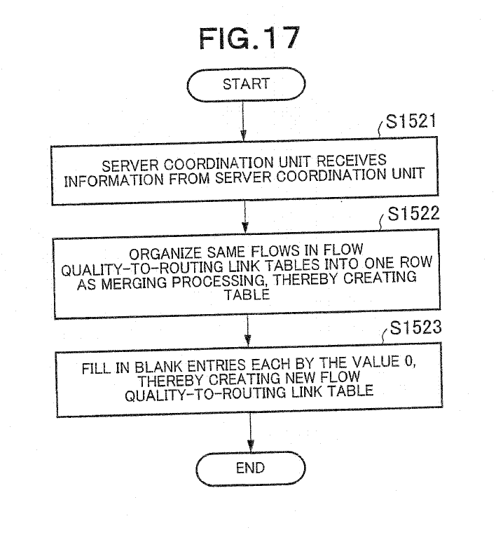

The processing performed by the table processing unit SA12 at the step S152 will be described in more detail with reference to the flowchart shown in FIG. 17.

When receiving the information from the server coordination unit SA11 (step S1521), the table processing unit SA12 organizes the same flows in the flow quality-to-routing link tables S151 of the sub-networks N1 to N3 into one row in the information received at the step S121, based on values in cells of PrevNet and NextNet in each of the flow quality-to-routing link tables S151 of the sub-networks N1 to N3, thereby creating one table (step S1522).

Next, the table processing unit SA12 fills in blank entries of the table created by the merging processing at the step S122 each by the value 0, thereby creating the flow quality-to-routing link table SA121 (step S1523).

A specific example of the processing performed by the point-of-quality-degradation estimation unit SA14 at the step S153 will be described.

To perform the processing performed by the point-of-quality-degradation estimation unit SA14 at the step S153 will be described, the minimum-links estimation method described in “Estimating points of QoS degradation in the network from the aggregation of per-flow quality information”, IEICE technical report TM-2004-107 or the method described in “Method of managing voice quality per call in IP network”, Japanese Patent Application Laid-Open No. 2002-271932 can be used.

For example, if the minimum-links estimation method is used, the following estimation processing is performed.

Namely, if a certain link set (a set of columns of the table) is selected, then the point-of-quality-degradation estimation unit SA14 estimates minimum links of a sum of sets of routing links through which the respective flows pass and which constitute the link set through any one of which each of the flows always passes as points of degradation.

As a result of this estimation processing, if the table is, for example, the flow quality-to-routing link table SA121 shown in FIG. 13, the three links {L1-17, L2-24, L3-7} are estimated as points of degradation in the network 100.

Moreover, if the method described in “Method of managing voice quality per call in IP network”, Japanese Patent Application Laid-Open No. 2002-271932 is used, links (columns of links) through which a plurality of flows passes are estimated as points of quality degradation for the respective links (columns of links) of the table.

For example, if the table is, for example, the flow quality-to-routing link table SA121 shown in FIG. 13, the number of cells set to 1 is two in the three links (columns of links) 1-17, 2-24, and 3-7 and the number of cells set to 1 in the other links is one. Therefore, the three links (columns of links) 1-17, 2-24, and 3-7 are estimated as points of quality degradation in the network 100.

(Advantages of the First Embodiment)

According to the first embodiment, the entire network 100 is divided into the sub-networks N1 to N3, and each of the sub-networks N1 to N3 collects the communication characteristic information and the route information only on the flows passing through the sub-networks N1 to N3, thereby distributing collection load in relation to network information and performing parallel processing. It is thereby possible to reduce processing time required for the flow quality processing.

Furthermore, according to the first embodiment, even the non-degradation link removal processing is distributed to the non-degradation link removal processing units S15 of the respective sub-networks N1 to N3 and performed in parallel. It is thereby possible to reduce processing time required for the processing of estimating points of quality degradation.

### Second Embodiment

A second embodiment of the present invention differs from the first embodiment in the following respects. A sub-network point-of-quality-degradation estimation server S1 performs a non-degradation link removal processing on a sub-network for a processing in which the sub-network point-of-quality-degradation estimation server S1 is responsible, and a point-of-quality-degradation estimation processing as much as possible based on partial information. Further, an entire network point-of-quality-degradation estimation server SA1 performs a point-of-quality-degradation estimation processing on portions which the sub-network point-of-quality-degradation estimation server S1 cannot perform the estimation processing.

In the following description, flows passing through only each of sub-networks N1 to N3 for a processing in each of which each of sub-network point-of-quality-degradation estimation servers S1 to S3 is responsible (without passing through the other networks) will be referred to as “internal flows” and the other flows will be referred to as “external flows”.

(Explanation of Configuration According to the Second Embodiment)

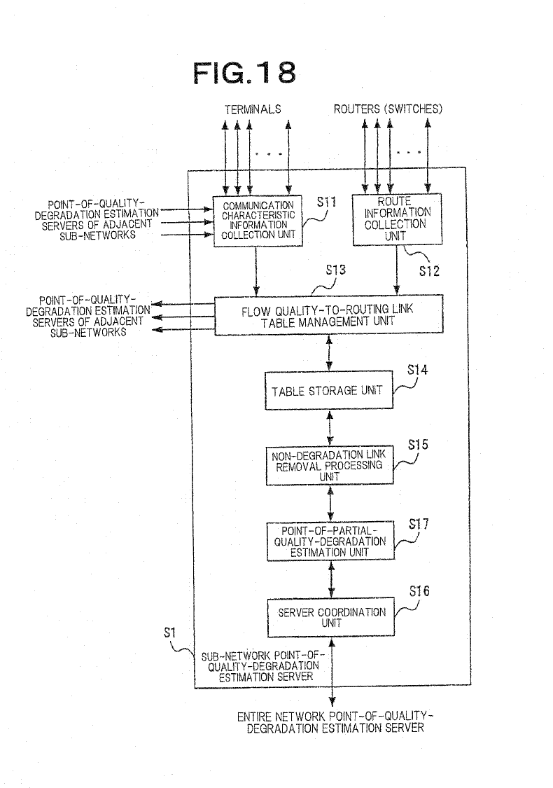

FIG. 18 is an internal configuration diagram of each of the sub-network point-of-quality-degradation estimation servers according to the second embodiment.

The sub-network point-of-quality-degradation estimation servers S1 to S3 according to the second embodiment differ from those according to the first embodiment only in that a point-of-partial-quality-degradation estimation unit S17 is additionally included in each of the sub-network point-of-quality-degradation estimation servers S1 to S3. Therefore, the sub-network point-of-quality-degradation estimation servers S1 to S3 will be appropriately described while centering about the different respect.

The point-of-partial-quality-degradation estimation unit S17 according to the second embodiment includes functions of receiving flow quality information, route information and the like extracted from the flow quality-to-routing link able S151 created by causing the non-degradation link removal processing unit S15 to perform the non-degradation link removal processing from the non-degradation link removal processing unit S15, estimating points of quality degradation of links based on the received information, and transmitting information on the estimated points of quality degradation to the server coordination unit S16.

The server coordination unit S16 according to the second embodiment includes a function of holding a communication between the sub-network point-of-quality-degradation estimation server S1 and the entire network point-of-quality-degradation processing server SA1. Further, the server coordination unit S16 receives the flow quality information, the routing link information, and information on an external block (to be described later) and on the estimated points of quality degradation output from the point-of-partial-quality-degradation estimation unit S17, and transmits these pieces of information to the entire network point-of-quality-degradation processing server SA1.

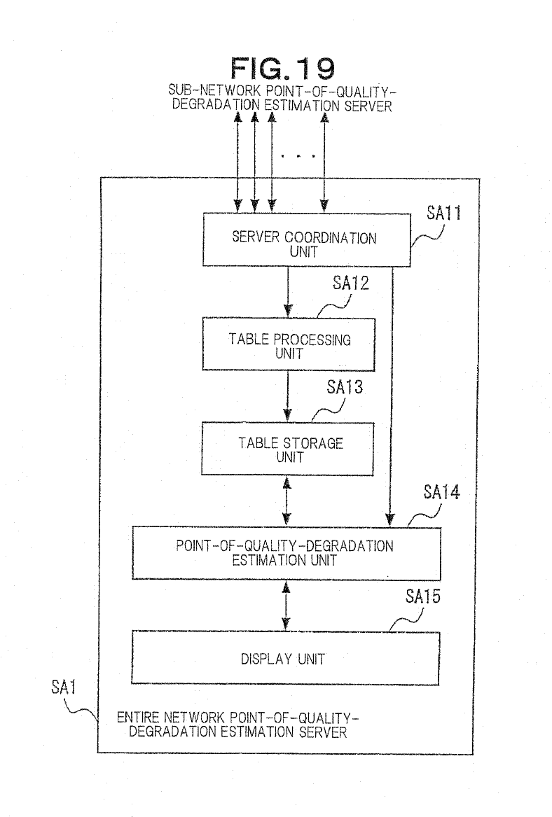

FIG. 19 is an internal configuration diagram of the entire network point-of-quality-degradation estimation server SA1 according to the second embodiment.

The entire network point-of-quality-degradation estimation server SA1 according to the second embodiment differs from that according to the first embodiment in the following respects. A point-of-quality-degradation estimation unit SA14 reads a flow quality-to-routing link table from a table storage unit SA13 on regular basis, and receives point-of-quality-degradation information on the sub-networks N1 to N3 from a server coordination unit SA11.

The server coordination unit SA11 includes functions of receiving information indicating external blocks and points of quality degradation transmitted from respective sub-network point-of-quality-degradation estimation servers S1 to S3, transmitting the information indicating the external blocks to a table processing unit SA12, and transmitting the information indicating the points of quality degradation to the point-of-quality-degradation estimation unit SA14.

The table processing unit SA12 according to the second embodiment includes a function of performing a merging processing on the external block in each of the flow quality-to-routing link tables S151 of the respective sub-networks N1 to N2 transmitted from the server coordination unit SA11, and the like.

The point-of-quality-degradation estimation unit SA14 according to the second embodiment includes functions of estimating points of quality degradation according to the operation performed by the point-of-quality-degradation estimation unit SA14 according to the first embodiment, and transmitting a set of sums of a result of the estimation and the points of quality degradation received from the server coordination unit SA11 to a display unit SA15.

(Explanation of Operation According to the Second Embodiment)

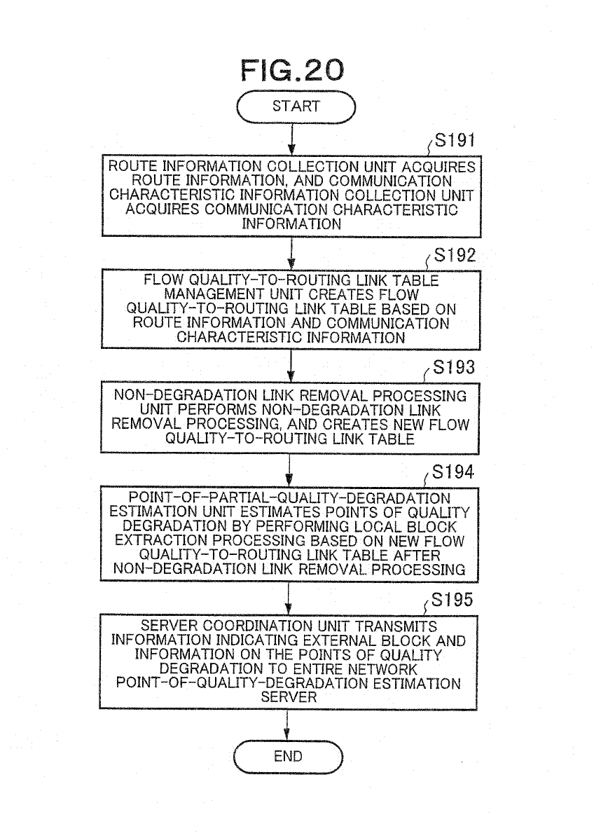

FIG. 20 is a flowchart showing operation performed by the sub-network point-of-quality-degradation estimation server S1 according to the second embodiment.

Since steps S191 to S193 shown in FIG. 20 are similar to the steps S131 to S133 shown in FIG. 14, respectively, they will not be described.

At a step S194, the point-of-partial-quality-degradation estimation unit S17 estimates points of quality degradation by performing a local block extraction processing (to be described later) based on the flow quality-to-routing link table SA151 after the non-degradation link removal processing.

At a step S195, the server coordination unit S16 transmits the information indicating an external block and the information on the points of quality degradation estimated at the step S24 to the entire network point-of-quality-degradation estimation server SA1.

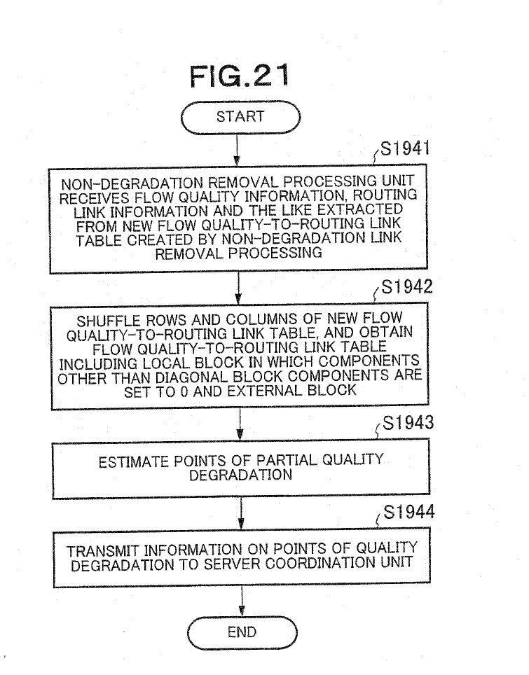

The processing (local block extraction processing) performed by the point-of-partial-quality-degradation estimation unit S17 at the step S194 will be described in more detail with reference to the flowchart shown in FIG. 21.

First, the point-of-partial-quality-degradation estimation unit S17 receives the flow quality information, the routing link information and the like extracted from the flow quality-to-routing link table created by the non-degradation link removal processing from the non-degradation link removal processing unit S15 (step S1941). The point-of-partial-quality-degradation estimation unit S17 shuffles rows and columns of the flow quality-to-routing link table, and obtain a flow quality-to-routing link table including a local block (to be described later) in which components other than diagonal block components are set to 0 and an external block (step S1942), thereby estimates points of partial quality degradation (step S1943), and transmits information on the estimated points of quality degradation to the server coordination unit S16 (step S1944).

If two certain flows pass through the same link (route), the two flows are referred to as “flows having common link”. The local block corresponds to a portion relating to internal flows (pure internal flows) having no common links to the external flow and an internal flow having a common link to the external flow in the flow quality-to-routing link table of each of the sub-networks, and obtained by extracting rows of the pure internal flows and columns of links through which any one of those pure internal flows passes.

Further, the external block corresponds to a portion relating to internal flows other than the pure internal flows or relating to external flows in the flow quality-to-routing link table of each of the sub-networks, and obtained by extracting rows of the internal flows other than the pure internal flows or rows of the external flows and columns of links through which any one of those flows passes.

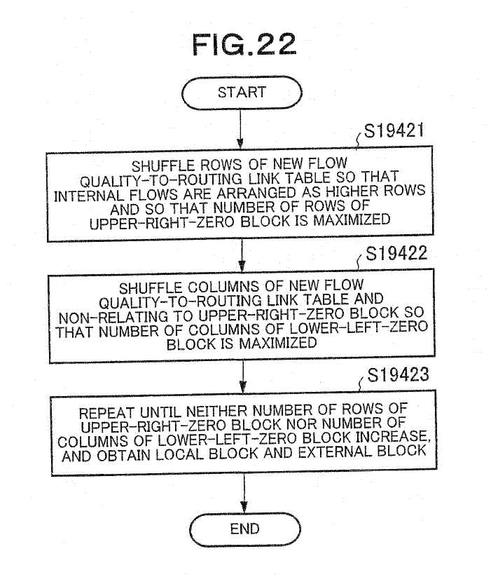

Specific processing procedures of the step S1942 will be described with reference to the flowchart shown in FIG. 22.

In the specific processing procedures, the point-of-partial-quality-degradation estimation unit S17 performs a processing of shuffling rows of the flow quality-to-routing link table so that the internal flows are arranged as higher rows (while the external flows are arranged as lower flows) and so that the number of rows of a block in which a value of an upper right component is 0 (referred to as “upper-right-zero block”) is maximized (step S19421).

Next, the point-of-partial-quality-degradation estimation unit S17 performs a processing of shuffling columns of the flow quality-to-routing link table and non-relating to the upper-right-zero block so that the number of columns of a block in which a value of a lower left component is 0 (referred to as “lower-left-zero block”) is maximized (step S19422).

The processings (steps S19421 to S19422) are repeated until neither the number of rows of the upper-right-zero block nor the number of columns of the lower-left-zero block increase, and the local block and the external block are obtained (step S19423).

In the above-stated manner, the point-of-partial-quality-degradation estimation unit S17 performs a minimum-links estimation processing on the local block, estimates points of partial quality degradation by obtaining a set of links of quality degradation (quality-degradation link set), and notifies the server coordination unit S16 of the external block and a result of the estimation based on the quality-degradation link set.

Furthermore, the server coordination unit S16 transmits the information indicating the external block and that indicating the points of quality degradation as a result of the estimation received from the point-of-partial-quality-degradation estimation unit S17 to the entire network point-of-quality-degradation processing server SA1.

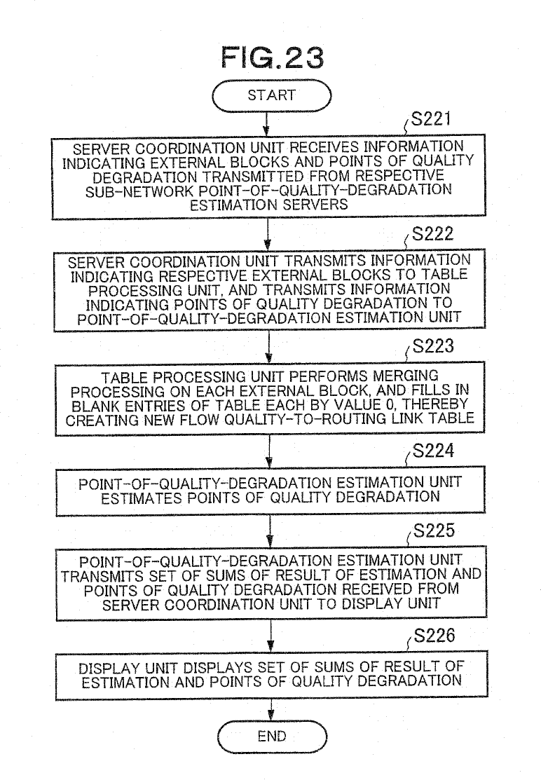

FIGS. 23A and 23B depict a flowchart showing operation performed by the entire network point-of-quality-degradation estimation server SA1 according to the second embodiment.

First, the server coordination unit SA11 receives the information indicating respective external blocks and points of quality degradation transmitted from the respective sub-network point-of-quality-degradation estimation servers S1 to S3 (step S221). Further, the server coordination unit SA11 transmits the information indicating the respective external blocks to the table processing unit SA12, and transmits the information indicating the points of quality degradation to the point-of-quality-degradation estimation unit SA14 (step S222).

The table processing unit SA12 performs a merging processing on the external block in each of the flow quality-to-routing link tables S151 of the respective sub-networks N1 to N3 based on the information transmitted from the server coordination unit SA11. Further, the table processing unit SA12 fills in blank entries of the table each by the value 0, thereby creating a flow quality-to-routing link table SA121 (step S223).

Since the merging processing is similar to that according to the first embodiment, it will not be described.

The point-of-quality-degradation estimation unit SA14 performs a processing of estimating points of quality degradation similarly to the point-of-quality-degradation estimation unit SA14 according to the first embodiment (step S224). Further, the point-of-quality-degradation estimation unit SA14 transmits a set of sums of a result of the estimation processing and the points of quality degradation received from the server coordination unit SA11 to the display unit SA15 (step S225).

The display unit SA15 displays the set of sums of the result of the estimation processing and the points of quality degradation received from the point-of-quality-degradation estimation unit SA14 (step S226).

The operation according to the second embodiment will be described while referring to a specific example.

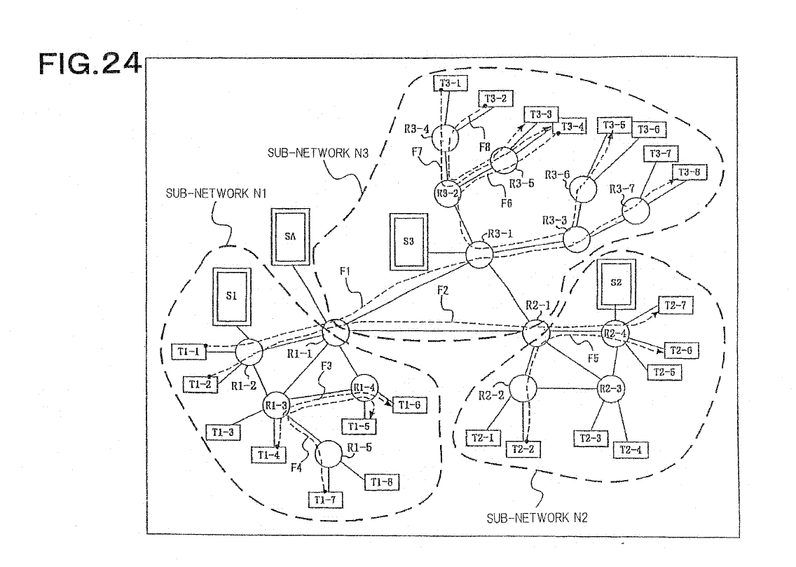

It is assumed that flows F1 to F8 shown in FIG. 24 are present and qualities of all these flows degrade in the network configuration shown in FIGS. 1 and 3.

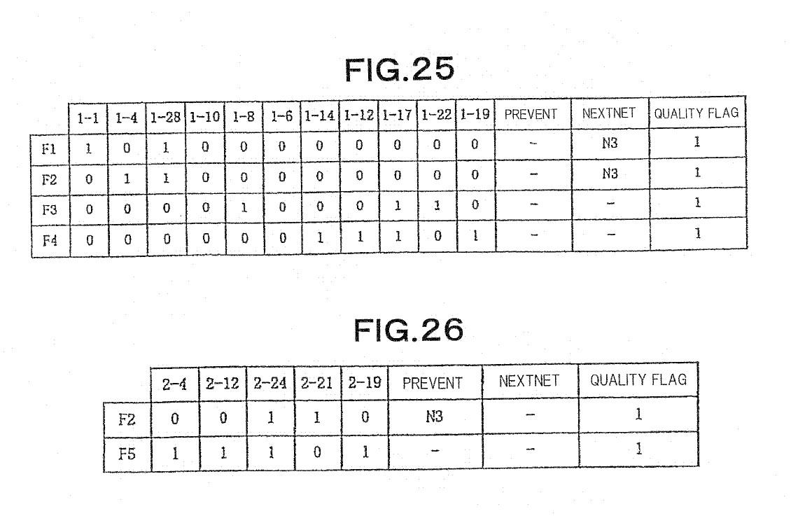

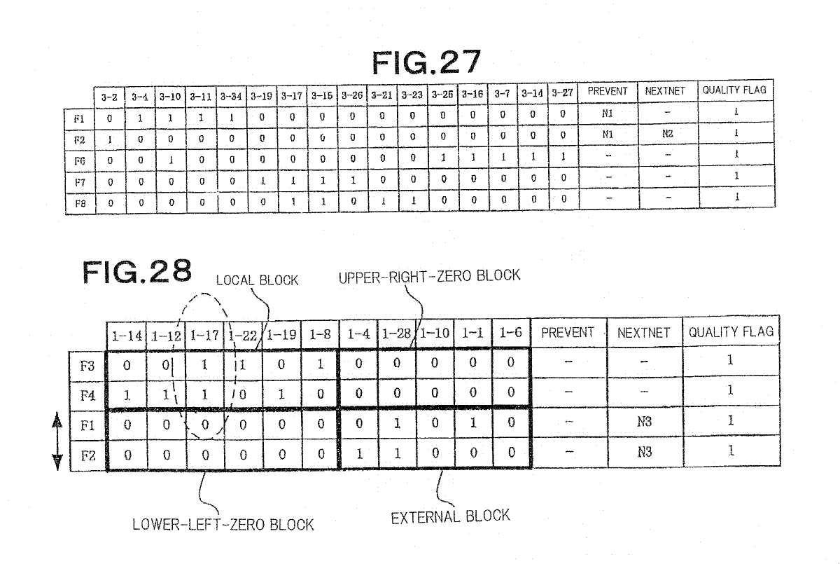

In this assumption, the flow quality-to-routing link tables stored in the table storage units S14 of the sub-network point-of-quality-degradation estimation servers S1 to S3 are tables as shown in FIGS. 25 to 27, respectively.

FIGS. 25 to 27 show the flow quality-to-routing link tables of the sub-networks N1 to N3, respectively.

Since all the qualities of the flows F1 to F8 degrade, the tables have no change even after the non-degradation link removal processing performed by the non-degradation link removal processing unit S15 and information on the tables shown in FIGS. 25 to 27 is transmitted to the point-of-partial-quality-degradation estimation unit S17.

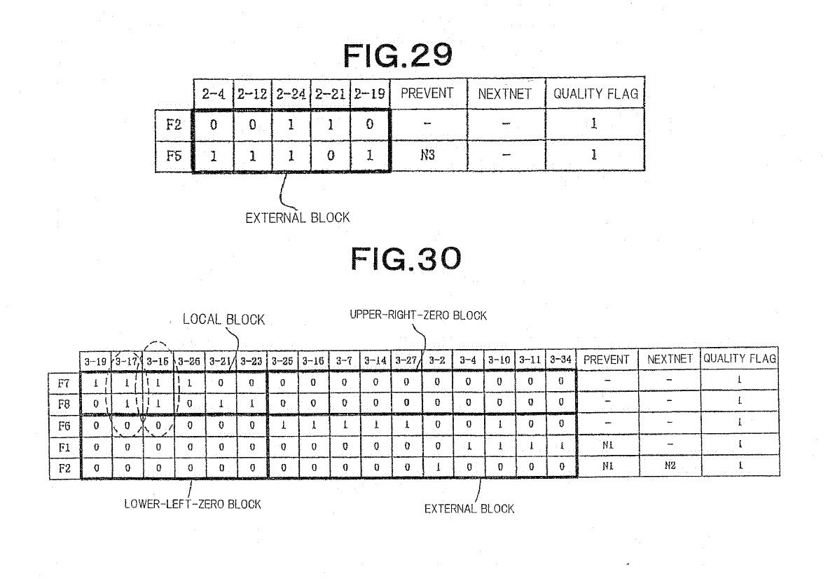

The point-of-partial-quality-degradation estimation unit S17 performs the local block extraction processing, thereby extracting local blocks as shown in the tables of FIGS. 28 to 30.

FIGS. 28 to 30 show the flow quality-to-routing link tables of the sub-networks N1 to N3 after the local block extraction processing, respectively.

At the step S194, the minimum-links estimation processing is performed. The point-of-partial-quality-degradation estimation unit S17 of the sub-network estimation server S1 estimates {L1-17} as a point of quality degradation, and the point-of-partial-quality-degradation estimation unit S17 of the sub-network estimation server S3 estimates {L3-17} and {L3-15} as points of quality degradation.

At the step S195, the server coordination unit S16 is notified of these estimation results and external blocks.

The server coordination unit SA11 of the entire network point-of-quality-degradation estimation server receives {L1-17, L3-17, L3-15} as the points of quality degradation from the server coordination units S16 of the respective sub-network point-of-quality-degradation estimation servers S1 to S3, and transmits {L1-17, L3-17, L3-15} to the point-of-quality-degradation estimation unit SA14. Further, the server coordination unit SA11 receives the information indicating the external blocks of the tables shown in FIGS. 28 to 30, respectively, and transmits the information to the table processing unit SA12.

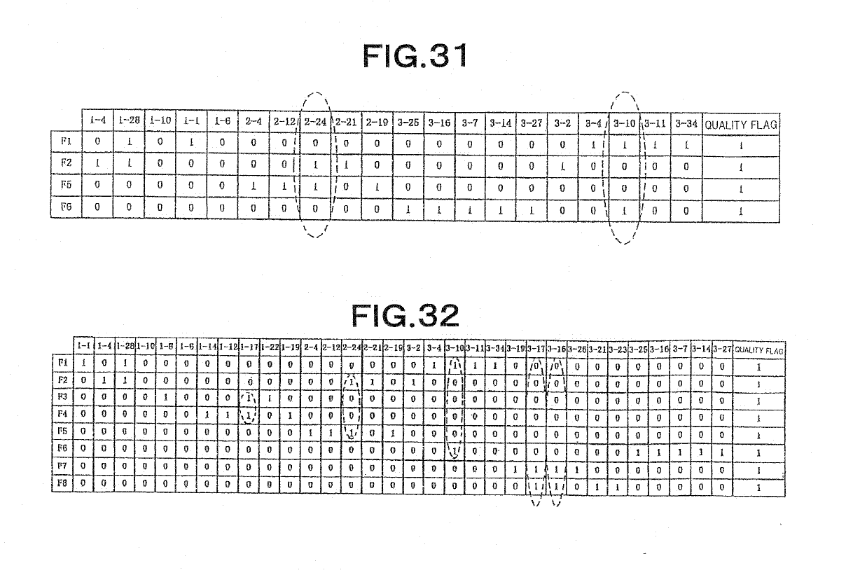

The table processing unit SA12 performs a merging processing on the external blocks based on the information transmitted from the server coordination unit SA11. Further, the table processing unit SA12 creates a merging-processed table relating to the external blocks as shown in FIG. 31, and stores the created merging-processed table relating to the external blocks in the table storage unit SA13.

The point-of-quality-degradation estimation unit SA14 performs the minimum-links estimation processing on the merging-processed table relating to the external blocks and stored in the table storage unit SA13, thereby obtaining {L2-24, L3-10} as an estimation result.

The point-of-quality-degradation estimation unit SA14 transmits a set of sums {L1-17, L2-24, L3-10, L3-15, L3-17} of the estimation result obtained by performing the minimum-links estimation processing and the points of quality degradation {L1-17, L3-17, L3-15} notified by the server coordination unit SA11 to the display unit SA15 as a final estimation result.

The display unit SA15 displays the routing links {L1-17, L2-24, L3-10, L3-15, L3-17} as the final result.

FIG. 32 is a flow quality-to-routing link table after flow information on the entire network is collected and the non-degradation link removal is performed according to a conventional method.

In this case, a result of the minimum-links estimation processing is {L1-17, L2-24, L3-10, L3-15, and L3-17}. Therefore, the estimation result according to the second embodiment is identical with that according to the conventional method.

(Advantages of the Second Embodiment)

According to the second embodiment, it is possible to not only attain the advantages of the first embodiment but also reduce processing time required for the processing of estimating points of quality degradation since the point-of-quality-degradation estimation units S17 of the respective sub-networks N1 to N3 perform part of the processings of estimating points of quality degradation in parallel.

### Third Embodiment

A third embodiment of the present invention is similar to the second embodiment in configurations and functions of the sub-network point-of-quality-degradation estimation servers S1 to S3. However, the third embodiment differs from the second embodiment in operation performed by each of the sub-network point-of-quality-degradation estimation servers S1 to S3, i.e., in a point-of-partial-quality-degradation estimation unit S17 and a server coordination unit S16. Furthermore, the third embodiment differs from the second embodiment in a server coordination unit SA11 and a table processing unit SA12 of an entire network point-of-quality-degradation estimation server SA1. Therefore, the third embodiment will be described while centering about the different respects.

In the following description, similarly to the second embodiment, flows passing through only each of sub-networks N1 to N3 for a processing in each of which each of the sub-network point-of-quality-degradation estimation servers S1 to S3 is responsible (without passing through the other networks) will be referred to as “internal flows” and the other flows will be referred to as “external flows”.

(Explanation of Configuration According to the Third Embodiment)

The point-of-partial-quality-degradation estimation unit S17 according to the third embodiment is similar in configuration and functions to that according to the second embodiment except for the following respect. The point-of-partial-quality-degradation estimation unit S17 according to the third embodiment particularly includes a function (not shown) of notifying the server coordination unit S16 of a set of links of quality degradation, flow identifiers of solved external flows, and row information of unsolved external flows (flow identifiers, routing links, PrevNet, NextNet, and quality flag information).

Among the external flows, an external flow passing through at least an internal flow-limited estimated point will be referred to as “solved external flow”, and otherwise referred to as “unsolved external flow”.

The “internal flow limited estimated point” means a point obtained as an estimation result of performing a minimum-links estimation processing on a set of rows of only internal flows in the flow quality-to-routing link table and of estimating a set of links of quality degradation.

The server coordination unit S16 according to the third embodiment is similar in configuration and functions to that according to the second embodiment except for the following respect. The server coordination unit S16 according to the third embodiment particularly includes a function (not shown) of transmitting the set of links of quality degradation, the flow identifiers of solved external flows, and the information on rows of unsolved external flows received from the point-of-partial-quality-degradation estimation unit S17 to the entire network point-of-quality-degradation estimation server SA1.

The server coordination unit SA11 according to the third embodiment is similar in configuration and functions to that according to the second embodiment except for the following respects. The server coordination unit SA11 according to the third embodiment particularly includes functions (not shown) of receiving the sets of links of quality degradation, the flow identifiers of solved external flows, and the information on rows of unsolved external flows transmitted from the respective sub-network point-of-quality-degradation estimation servers S1 to S3, transmitting the flow identifiers of solved external flows, and the information on rows of unsolved external flows to the table processing unit SA12, and transmitting the sets of links of quality degradation to the point-of-quality-degradation estimation unit S14.

The table processing unit SA12 according to the third embodiment is similar in configuration and functions to that according to the second embodiment except for the following respect. The table processing unit SA12 according to the third embodiment particularly includes a function (not shown) of deciding flow identifiers of unsolved external flows in all the sub-networks N1 to N3 based on the solved external flow identifiers and the information on rows of unsolved external flows received from the server coordination unit SA11.

Furthermore, the table processing unit SA12 according to the third embodiment performs a merging processing based on the decided flow identifiers of unsolved external flows and the information notified by the respective sub-networks N1 to N3 similarly to the second embodiment, and also fills in blank entries of the tables each by the value 0.

The merging processing according to the third embodiment will be described.

In each of the sub-networks N1 to N3 according to the third embodiment, the directed links are uniquely set and the same link number is not, therefore, set repeatedly similarly to the second embodiment. Accordingly, the same link number appears on only one sub-network table. Further, the same flow includes the same quality flag.

Due to this, the table processing unit SA12 according to the third embodiment can organize the same flows in the flow quality-to-routing link tables S151 of the sub-networks N1 to N3 into one row based on values in cells of PrevNet and NextNet in each of the flow quality-to-routing link tables S151 of the sub-networks N1 to N3 and on the decided flow identifiers of unsolved external flows, and create one table from the respective flow quality-to-routing link tables S151. This is referred to as “merging processing”.

(Explanation of Operation According to the Third Embodiment)

Operations performed by the sub-network point-of-quality-degradation estimation servers S1 to S3 according to the third embodiment are similar to those performed by the sub-network point-of-quality-degradation estimation servers S1 to S3 according to the second embodiment, but differ from operations performed by the sub-network point-of-quality-degradation estimation servers S1 to S3 according to the second embodiment on the point that the point-of-partial-quality-degradation estimation unit S17 according to the third embodiment obtains internal flow-limited estimated points, solved external flows, and unsolved external flows.

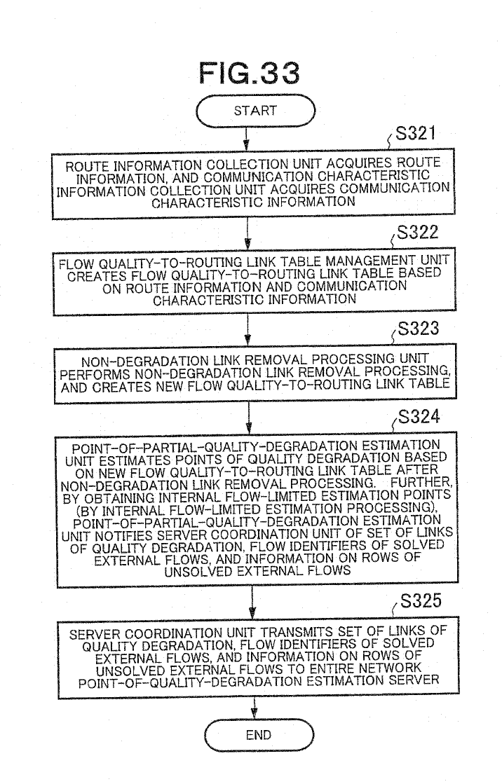

FIG. 33 is a flowchart showing operation performed by the sub-network point-of-quality-degradation estimation server S1 according to the third embodiment.

Since steps S321 to S323 shown in FIG. 33 are similar to the steps S131 to S133 shown in FIG. 14, respectively, they will not be described.

At a step S324, the point-of-partial-quality-degradation estimation unit S17 estimates points of quality degradation based on the flow quality-to-routing link table SA151 after the non-degradation link removal processing. Further, by obtaining internal flow-limited estimation points (by the internal flow-limited estimation processing), the point-of-partial-quality-degradation estimation unit S17 notifies the server coordination unit S16 of the set of links of quality degradation, the flow identifiers of solved external flows, and the information on rows of unsolved external flows.

At a step S325, the server coordination unit S16 transmits the set of links of quality degradation, the flow identifiers of solved external flows, and the information on rows of unsolved external flows to the entire network point-of-quality-degradation estimation server SA1.

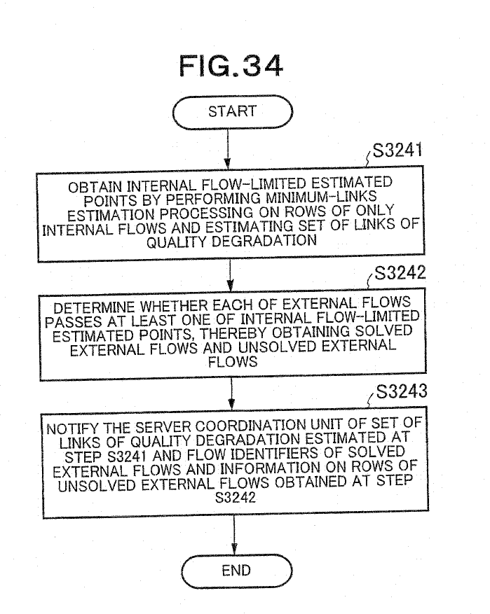

The processing (internal flow-limited estimation processing) performed by the point-of-partial-quality-degradation estimation unit S17 at the step S334 will be described in more detail with reference to the flowchart shown in FIG. 34.

First, the point-of-partial-quality-degradation estimation unit S17 obtains internal flow-limited estimated points by performing the minimum-links estimation processing on the rows of only internal flows in the flow quality-to-routing link table S151 and estimating the set of links of quality degradation (step S3241).

Next, the point-of-partial-quality-degradation estimation unit S17 determines whether each of the external flows passes at least one of the internal flow-limited estimated points obtained at the step S541, thereby obtaining the solved external flows or unsolved external flows (step S3242).

Finally, the point-of-partial-quality-degradation estimation unit S17 notifies the server coordination unit S16 of the set of links of quality degradation estimated at the step S3241 and the flow identifiers of the solved external flows and the information on rows of the unsolved external flows obtained at the step S3242 (step S3243).

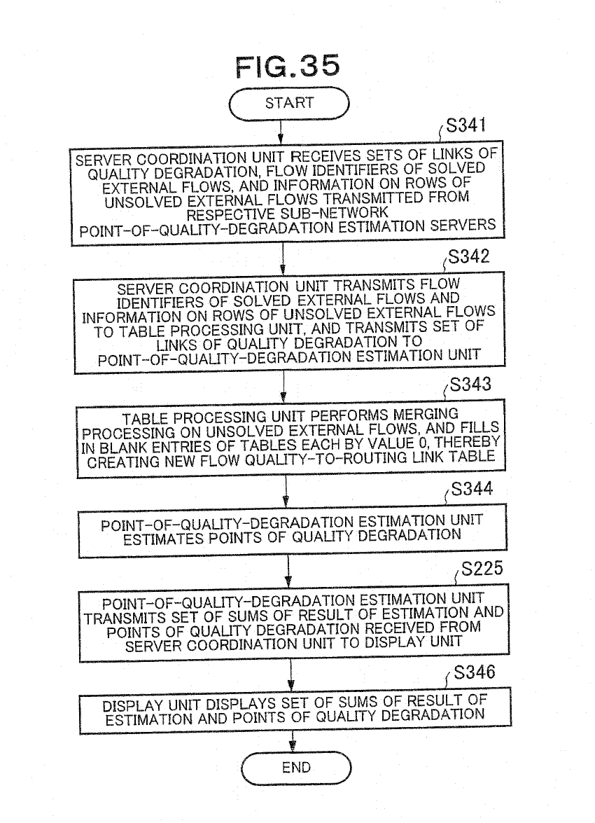

FIG. 35 is a flowchart showing operation performed by the entire network point-of-quality-degradation estimation server SA1 according to the third embodiment.

First, the server coordination unit SA11 receives the sets of links of quality degradation, the flow identifiers of solved external flows, and the information on rows of unsolved external flows transmitted from the respective sub-network point-of-quality-degradation estimation servers S1 to S3 (step S341). Further, the server coordination unit SA11 transmits the flow identifiers of solved external flows and the information on rows of unsolved external flows to the table processing unit SA12, and transmits the set of links of quality degradation to the point-of-quality-degradation estimation unit SA14 (step S342).

The table processing unit SA12 decides flow identifies of unsolved external flows in all of the sub networks N1 to N3 based on the information received from the server coordination unit SA11. Further, the table processing unit SA12 performs the merging processing according to the third embodiment based on the decided flow identifies of unsolved external flows and the information notified by the respective sub-networks N1 to N3. Moreover, the table processing unit SA12 fills in blank entries of the tables each by the value 0, thereby creating a flow quality-to-routing link table SA121 according to the third embodiment (step S343).

Since steps S344 to S346 are similar to the steps S224 to S226 according to the second embodiment, they will not be described.

The operation according to the third embodiment will be described while referring to a specific example.

It is assumed that flows F1 to F8 shown in FIG. 4 are present and qualities of all these flows degrade in the network shown in FIG. 1.

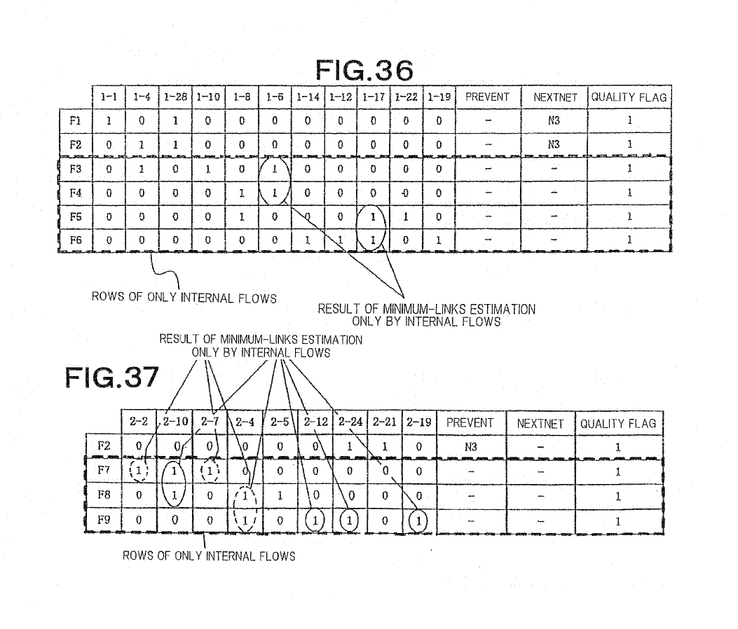

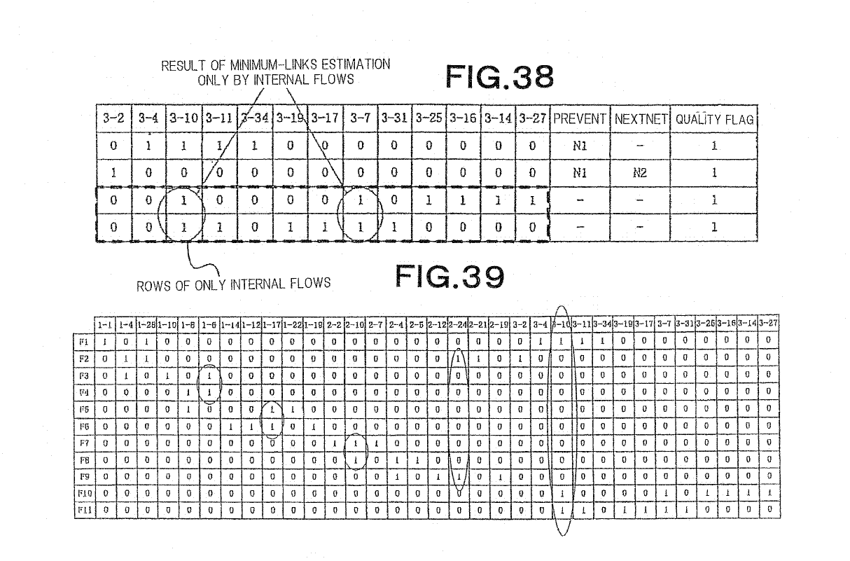

In this assumption, the flow quality-to-routing link tables S131 stored in the table storage units S14 of the sub-network point-of-quality-degradation estimation servers S1 to S3 are tables as shown in FIGS. 36 to 38, respectively.

Since all the qualities of the flows F1 to F8 degrade, the tables shown in FIGS. 36 to 38 have no change even after the non-degradation link removal processing performed by the non-degradation link removal processing unit S15 and information on the tables shown in FIGS. 36 to 38 is transmitted to the point-of-partial-quality-degradation estimation unit S17.

Parts surrounded by thick dotted lines are rows of only internal flows in the tables shown in FIGS. 36 to 38, respectively.

Next, the point-of-partial-quality-degradation estimation unit S17 performs the internal flow-limited estimation processing.

In the sub-network N1, the flows F1 and F2 are external flows and the flows F3, F4, F5, and F6 are internal flows. In the sub-network N2, the flow F2 is an external flow and the flows F7, F8, and F9 are internal flows. In the sub-network N3, the flows F1 and F2 are external flows and the flows F10 and F11 are internal flows.

At the step S541, the minimum-links estimation processing is performed on the rows of only internal flows surrounded by the thick dotted line in each of the tables shown in FIGS. 36 to 38.

As a result of this estimation processing, links {L1-6, L1-17} are estimated as links of quality degradation in the sub-network N1. Links {L2-2, L2-4}, {L2-7, L2-4}, {L2-10, L2-4}, {L2-12, L2-10}, {L2-24, L2-10}, and {L2-19, L2-10} are estimated in the sub-network N2, and {L3-10} and {L3-7} are estimated in the sub-network N3.

Next, a list of all the links included in the result of the estimation processing is output as the set of links of quality degradation.

Namely, the links {L1-6, L1-17} are output in the sub-network N1, {L2-2, L2-4, L2-7, L2-12, L2-24, L2-19, L2-10} are output in the sub-network N2, and {L3-10, L3-7} are output in the sub-network N3.

At the step S542, the point-of-partial-quality-degradation estimation unit S17 decides the solved external flows and unsolved external flows.

Namely, in the sub-network N1, since the external flows F1 and F2 do not pass through any links in the set of links of quality degradations {L1-6, L1-17}, the external flows F1 and F2 are both unsolved external flows.

Namely, in the sub-network N2, since the external flow F2 passes through the link L2-24 included in the set of links of quality degradation {L2-2, L2-4, L2-7, L2-12, L2-24, L2-19, L2-10}, the external flow F2 is a solved external flow.

Namely, in the sub-network N3, since the external flow F1 passes through the link L3-10 included in the set of links of quality degradation {L3-10, L3-7}, the flow F1 is a solved external flow. Since the external flow F2 does not pass through any links included in the set of links of quality degradations {L3-10, L3-7}, the external flow F2 is an unsolved external flow.

At the step S543, the point-of-partial-quality-degradation estimation unit S17 notifies the server coordination unit S16 of the set of links of quality degradation obtained at the step S541 and the flow identifiers of the solved external flows and the information on rows of the unsolved external flows obtained at the step S542.

The server coordination unit S16 notifies the entire network estimation server SA1 of these pieces of information.

The server coordination unit SA11 of the entire network estimation server SA1 notifies the point-of-quality-degradation estimation unit SA14 of the sets of links of quality degradation {L1-6, L1-17}, {L2-2, L2-4, L2-7, L2-12, L2-24, L2-19, L2-10}, and {L3-10, L3-7} notified by the sub-network point-of-quality-degradation estimation servers S1 to S3 in the respective sub-networks N1 to N3.

Further, the server coordination unit SA11 transmits the flow identifiers of solved external flows and the information on rows of unsolved external flows notified by the sub-network point-of-quality-degradation estimation servers S1 to S3 to the table processing unit SA12.

The table processing unit SA12 performs the following processing.

First, the external flows notified from the respective sub-networks N1 to N3 are the flows F1 and F2. The flow F1 is the solved flow in the sub-network N3 and the flow F2 is the solved flow in the sub-network N2.

Due to this, the flow identifier of the unsolved external flow in all the sub-networks N1 to N3 is not present.

In this specific example, therefore, there is no table subjected to the merging processing by the table processing unit SA12.

Due to this, the point-of-quality-degradation estimation unit SA14 does not perform the minimum-links estimation processing and no points of quality degradation are estimated according to the operation performed by the point-of-quality-degradation estimation unit SA14 according to the first embodiment, accordingly. Therefore, the sets of links of quality degradation {L1-6, L1-17, L2-2, L2-4, L2-7, L2-12, L2-24, L2-19, L2-10, L3-10, L3-7} notified by the server coordination unit SA11 are transmitted to the display unit S15 as the final result.

The display unit S15 displays the final result of {L1-6, L1-17, L2-2, L2-4, L2-7, L2-12, L2-24, L2-19, L2-10, L3-10, L3-7}.

FIG. 39 is a flow quality-to-routing link table created by performing a non-degradation link removal processing on the flow information collected from all the networks in this specific example according to the conventional method.

In this case, the result of the minimum-links estimation processing is {L1-6, L1-17, L2-10, L2-24, L3-10}.

The result in the specific example of the third embodiment is {L1-6, L1-17, L2-2, L2-4, L2-7, L2-12, L2-24, L2-19, L2-10, L3-10, L3-7}. As compared with the conventional method, five other links {L2-2, L2-4, L2-10, L2-19, L3-7} are estimated as points of degradation.

(Advantages of the Third Embodiment)

According to the third embodiment, it is possible to not only attain the advantages of the first embodiment but also reduce processing time required for the processing of estimating points of quality degradation despite slight deterioration in accuracy for estimating points of quality degradation since part of the processings of estimating points of quality degradation is performed in the respective sub-networks N1 to N3 in parallel.

### Fourth Embodiment

A fourth embodiment of the present invention differs from the third embodiment in that a re-estimation unit S18 performing a re-estimation processing according to an instruction of a table processing unit SA12 of an entire network point-of-quality-degradation estimation server SA1 is added. The fourth embodiment will be described while centering around differences.

(Explanation of Configuration According to the Fourth Embodiment)

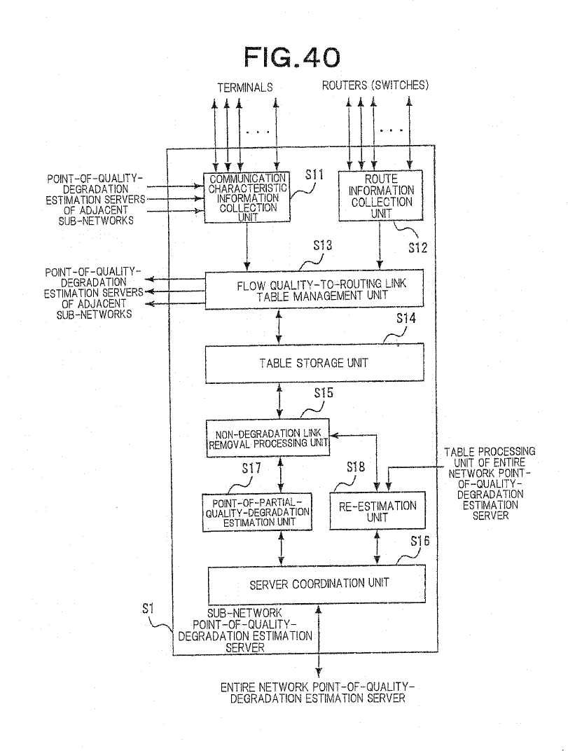

FIG. 40 is an internal configuration diagram of each of sub-network point-of-quality-degradation estimation servers S1 to S3 according to the fourth embodiment.

The sub-network point-of-quality-degradation estimation servers S1 to S3 according to the fourth embodiment differ from those according to the third embodiment in additionally including the re-estimation unit S18 including a function of exchanging information with a non-degradation link removal processing unit S15 and a server coordination unit S16.

The non-degradation link removal processing unit S15 according to the fourth embodiment includes not only the functions of the non-degradation link removal processing unit S15 of each of the sub-network point-of-quality-degradation estimation servers S1 to S3 according to the third embodiment but also a function of transmitting a flow quality-to-routing link table after the non-degradation link removal processing to the re-estimation unit S18 in response to a request from the re-estimation unit S18.

The re-estimation unit S18 includes a function of, when receiving an instruction of a re-estimation processing (to be described later) from the table processing unit SA12 of the entire network point-of-quality-degradation estimation server SA1 via the server coordination unit S16, receiving a flow identifier of an external flow for the re-estimation processing from the server coordination unit S16 and performing the estimation processing.

The server coordination unit S16 according to the fourth embodiment is similar in configuration and functions to that according to the third embodiment. However, the server coordination unit S16 according to the fourth embodiment includes not only the functions of the server coordination unit S16 according to the third embodiment but also a function of, if being notified of a set of links of quality degradation, flow identifiers of solved external flows, and information on rows of unsolved external flows (information on flow identifiers, routing links, PrevNet, NextNet, and quality flags) by the re-estimation unit S18, adding information indicating that the re-estimation processing is performed to the notified information and of notifying the entire network point-of-quality-degradation estimation server SA1 of these pieces of information.

The server coordination unit S16 according to the fourth embodiment also includes a function of, if being notified of a flow identifier of a predetermined flow by the server coordination unit SA11, transmitting the notified flow identifier to the re-estimation unit S18.

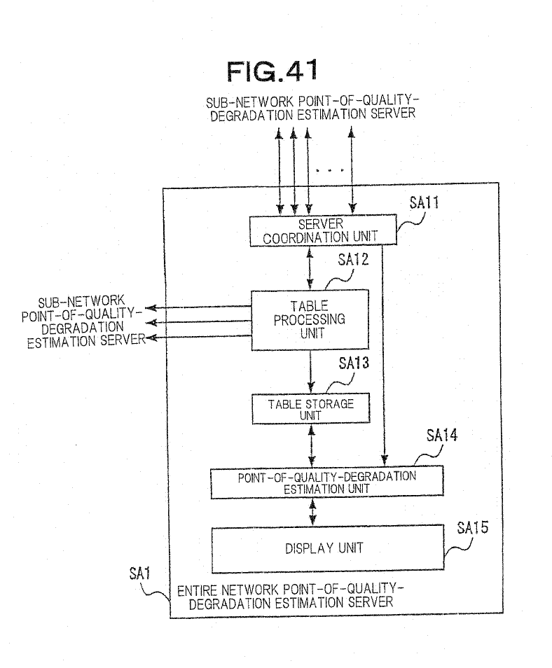

FIG. 41 is an internal configuration diagram of the entire network point-of-quality-degradation estimation server SA11 according to the fourth embodiment.

The entire network point-of-quality-degradation estimation server SA11 according to the fourth embodiment differs from that according to the third embodiment in that the table processing unit SA13 includes a function of instructing each of the sub-network point-of-quality-degradation estimation servers S1 to S3 to perform a re-estimation processing.

Similarly to the server coordination unit SA11 according to the third embodiment, the server coordination unit SA11 according to the fourth embodiment includes functions of receiving information on sets of links of quality degradation, flow identifiers of solved external flows, and row information on unsolved external flows from the respective sub-network point-of-quality-degradation estimation servers S1 to S3, transmitting the flow identifiers of solved external flows and the information on rows of unsolved external flows to the table processing unit SA12, and transmitting the information on sets of links of quality degradation to the point-of-quality-degradation estimation unit S14.

The server coordination unit SA11 according to the fourth embodiment also includes a function of transmitting information indicating that the re-estimation processing has been performed to the table processing unit SA12 and the point-of-quality-degradation estimation unit SA14 if the information transmitted from the respective sub-network point-of-quality-degradation estimation servers S1 to S3 includes the information indicating that the re-estimation processing has been performed.

The table processing unit SA12 according to the fourth embodiment includes a function of performing a predetermined processing based on whether the information transmitted from the server coordination unit SA11 includes the information indicating that the re-estimation processing has been performed. For example, the table processing unit SA12 instructs the re-estimation unit S18 of each of the point-of-quality-degradation estimation servers S1 to S3 to perform a re-estimation processing via the server coordination unit SA11 and the server coordination unit S16 for a predetermined instance.

The point-of-quality-degradation estimation unit SA14 according to the fourth embodiment will not be described in detail since the point-of-quality-degradation estimation unit SA14 is similar in configuration and functions to that according to the third embodiment. The sets of links of quality degradation of the respective sub-networks N1 to N3 received from the server coordination unit SA11 possibly include those including information indicating that the re-estimation processing has been performed and those not including the information. Therefore, the point-of-quality-degradation estimation unit SA14 uses the sets of links of quality degradation including the information indicating that the re-estimation processing has been performed (information received later) for the processing.

(Explanation of Operation According to the Fourth Embodiment)

Operations performed by the non-degradation link removal processing unit S15, the re-estimation unit S18, and the server coordination unit S16 of each of the sub-network point-of-quality-degradation estimation servers S1 to S3 and operations performed by the server coordination unit SA11, the table processing unit SA12, and the point-of-quality-degradation estimation unit SA14 of the entire network estimation server SA1 according to the fourth embodiment different from the operations according to the third embodiment will be mainly described.

The operation performed by each of the sub-network point-of-quality-degradation estimation servers S1 to S3 according to the fourth embodiment is similar to that according to the third embodiment if the entire network estimation server SA1 does not transmit a re-estimation processing request. Therefore, the operation will not be described herein.

The operation performed by each of the sub-network point-of-quality-degradation estimation servers S1 to S3 according to the fourth embodiment if the entire network point-of-quality-degradation estimation server SA1 transmits a re-estimation processing request will be described.

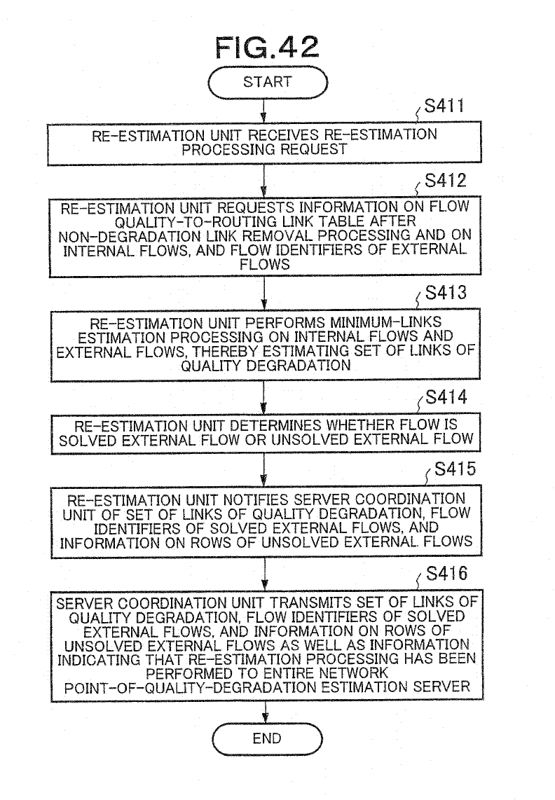

FIG. 42 is a flowchart showing an example of the operation performed by the sub-network estimation server S1 according to the fourth embodiment.

The re-estimation unit S18 receives a re-estimation processing request transmitted from the entire network estimation server SA1 (step S411).

When receiving the re-estimation processing request (step S411), the re-estimation unit S18 requests the non-degradation link removal processing unit S15 to transmit information on the flow quality-to-routing link table S151 after the non-degradation link removal processing and on internal flows, and the server coordination unit S16 to transmit flow identifiers of external flows (step S412).

The re-estimation unit S18 extracts rows of internal flows in the flow quality-to-routing link table S151 notified by the non-degradation link removal processing unit S15, and rows of external flows identified by the flow identifiers notified by the server coordination unit S16, performs a minimum-links estimation processing on those flows, and estimates a set of links of quality degradation such as an internal flow-limited estimated point or the like (step S413).

The re-estimation unit S18 determines whether the internal flow-limited estimated point passes through at least one route, thereby deciding the flow is a solved external flow or an unsolved external flow (step S414), and notifies the server coordination unit S16 of the set of links of quality degradation, flow identifiers of solved external flows, and information on rows of unsolved external flows (step S415).

Next, the server coordination unit S16 transmits the set of links of quality degradation, the flow identifiers of solved external flows, and the information on rows of unsolved external flows as well as the information indicating that the re-estimation processing has been performed to the entire network point-of-quality-degradation estimation server SA1 (step S416).

The above is an example of the operation performed by the sub-network point-of-quality-degradation estimation server S1 according to the fourth embodiment. Alternatively, at the step S412, the re-estimation unit S18 may request the non-degradation link removal processing unit S15 to transmit information on internal flows and on solved external flows identified by the flow identifiers received from the server coordination unit S16. At the step S413, the re-estimation unit S18 may perform the minimum-links estimation processing based on the information on the internal flows and on the solved external flows identified by the flow identifiers, and estimate the set of links of quality degradation. At the step S414, the re-estimation unit S18 may defines the internal flows and external flows other than the solved external flows identified by the flow identifiers as unsolved external flows.

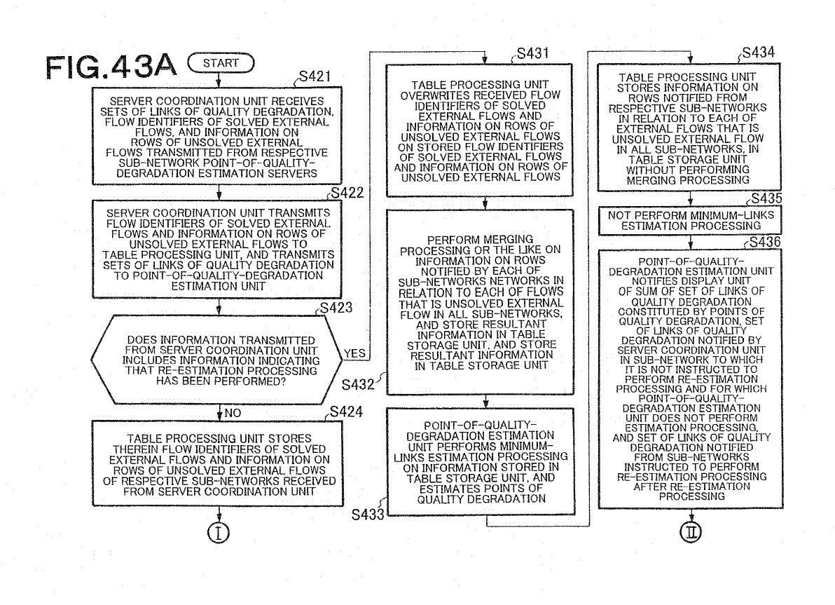

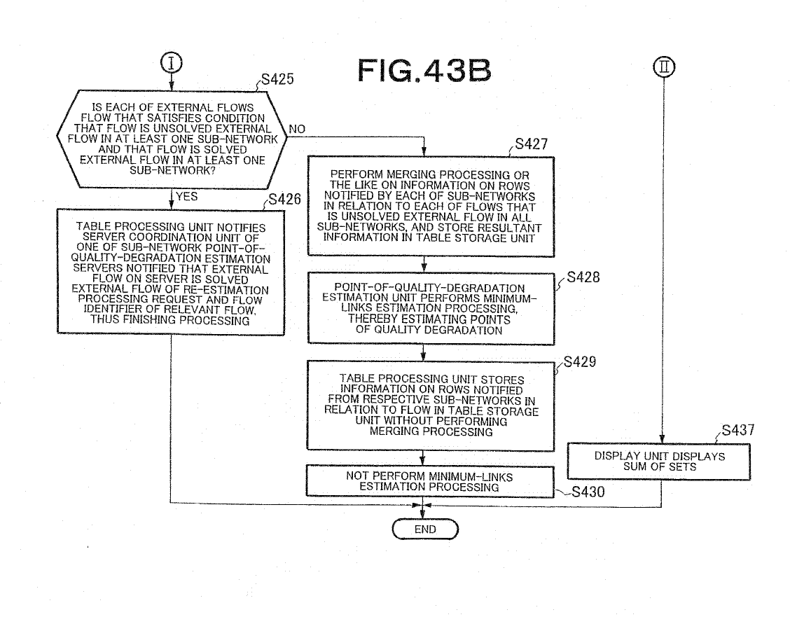

FIG. 43 is a flowchart showing operation performed by the entire network point-of-quality-degradation estimation server SA1 according to the fourth embodiment.

First, the server coordination unit SA11 receives the sets of links of quality degradation, the flow identifiers of solved external flows, and the information on rows of unsolved external flows transmitted from the respective sub-network point-of-quality-degradation estimation servers S1 to S3 (step S421), transmits the flow identifiers of solved external flows and the information on rows of unsolved external flows to the table processing unit SA12, and transmits the sets of links of quality degradation to the point-of-quality-degradation estimation unit SA14 (step S422).

The table processing unit SA12 determines whether the information transmitted from the server coordination unit SA11 includes information indicating that the re-estimation processing has been performed (step S423).

In this case, the table processing unit SA12 performs different operations between an instance in which the information transmitted from the server coordination unit SA11 includes information indicating that the re-estimation processing has been performed and an instance in which the information does not include information indicating that the re-estimation processing has been performed. Therefore, the different operations will be described.

First, the instance in which the information transmitted from the server coordination unit SA11 dose not include information indicating that the re-estimation processing has been performed will be described.

The table processing unit SA12 stores therein the flow identifiers of solved external flows and the information on rows of unsolved external flows of the respective sub-networks N1 to N3 received from the server coordination unit SA11 (step S424).

The table processing unit SA12 determines whether each of the external flows is a flow that satisfies a condition that the flow is an unsolved external flow in at least one sub-network and that the flow is a solved external flow in at least one sub-network (step S425).

If it is determined at the step S425 that the flow satisfying the condition is present, the table processing unit SA12 notifies the server coordination unit S16 of one of the sub-network point-of-quality-degradation estimation servers S1 to S3 notified that the external flow on the server is the solved external flow of a re-estimation processing request and the flow identifier of the relevant flow, thus finishing the processing (step S426).

If it is determined at the step S425 that the flow satisfying the condition is not present, the table processing unit SA12 performs a merging processing or the like on the information on rows notified by each of the sub-networks N1 to N3 in relation to each of the flows that satisfy the condition that the flow is an unsolved external flow in all the sub-networks N1 to N3 among the external flows, and stores the resultant information in the table storage unit SA13 (step S427).

The point-of-quality-degradation estimation unit SA14 performs the minimum-links estimation processing on the information stored in the table storage unit SA13 and estimates points of quality degradation (step S428).

Furthermore, if the external flows include any flow satisfying the condition that the flow is a solved external flow in all the sub-networks N1 to N3, then the table processing unit SA12 stores the information on rows notified from the respective sub-networks N1 to N3 in relation to the flow in the table storage unit SA13 without performing the merging processing (step S429), and the point-of-quality-degradation estimation unit SA14 does not perform the minimum-links estimation processing on the information stored in the table storage unit SA13 (step S430).

It is to be noted that the order of steps S425 to S430 is not limited to the above-stated order as long as the order of steps S425 to S426, the order of steps S427 to S428, and the order of steps S429 to S430 are those stated above.

Next, the instance in which the information transmitted from the server coordination unit SA11 includes information indicating that the re-estimation processing has been performed will be described.

First, when receiving the flow identifiers of solved external flows and the information on rows of unsolved external flows of the respective sub-networks N1 to N3 from the server coordination unit SA11, the table processing unit SA12 overwrites the received flow identifiers of the solved external flows and information on rows of unsolved external flows on the stored flow identifiers of the solved external flows and information on rows of unsolved external flows of the respective sub-networks N1 to N3 (step S431).

If a flow satisfying the condition that the flow is an unsolved external flow in all the sub-networks N1 to N3 is present among the stored external flows, the table processing unit SA12 performs a merging processing or the like on the information on rows notified by each of the sub-networks N1 to N3, and stores the resultant information in the table storage unit SA13 (step S432).

The point-of-quality-degradation estimation unit SA14 performs the minimum-links estimation processing on the information stored in the table storage unit SA13 and estimates points of quality degradation (step S433).

Furthermore, if the external flows include any flow satisfying the condition (1) that the flow is a solved external flow in all the sub-networks N1 to N3 or the condition (2) that the flow is an unsolved external flow at least in one of the sub-networks N1 to N3 and a solved external flow at least in one of the sub-networks N1 to N3, then the table processing unit SA12 stores the information on rows notified from the respective sub-networks N1 to N3 in relation to the flow in the table storage unit SA13 without performing the merging processing (step S434), and the point-of-quality-degradation estimation unit SA14 does not perform the minimum-links estimation processing on the information stored in the table storage unit SA13 (step S435).

The point-of-quality-degradation estimation unit SA14 notifies the display unit SA15 of a sum of sets of a set of links of quality degradation constituted by the points of quality degradation estimated at the steps S428 and S433, a set of links of quality degradation notified by the server coordination unit SA11 in the sub-network to which it is not instructed to perform the re-estimation processing and for which the point-of-quality-degradation estimation unit SA14 does not perform the estimation processing, and a set of links of quality degradation notified from the sub-networks instructed to perform the re-estimation processing at the step S426 after the re-estimation processing as a final result (step S436). The display unit SA15 displays the sum of sets (step S437).

It is to be noted that the order of steps S432 to S435 is not limited to the above-stated order as long as the order of steps S432 to S433 and the order of steps S434 to S435 are those stated above.

Moreover, the merging processing at the step S427 or S432 is similar to that performed by the table processing unit SA12 of the entire network point-of-quality-degradation estimation server SA1 according to the second embodiment. The merging processing will not be, therefore, described herein.

A specific example of the operation performed according to the fourth embodiment will be described while referring to the same example as that described in the third embodiment.

It is assumed that flows F1 to F8 shown in FIG. 4 are present and qualities of all these flows degrade in the network shown in FIG. 1.

In this assumption, the flow quality-to-routing link tables stored in the table storage units S14 of the sub-network point-of-quality-degradation estimation servers S1 to S3 are tables as shown in FIGS. 36 to 38, respectively similarly to the example of the operation described in the third embodiment.

Since all the qualities of the flows F1 to F8 degrade, the tables shown in FIGS. 36 to 38 have no change even after the non-degradation link removal processing performed by the non-degradation link removal processing unit S15 and information on the tables shown in FIGS. 36 to 38 is transmitted to the point-of-partial-quality-degradation estimation unit S17.

The point-of-partial-quality-degradation estimation unit S17 performs the internal flow-limited estimation processing.

In the sub-network N1, the flows F1 and F2 are external flows and the flows F3, F4, F5, and F6 are internal flows. In the sub-network N2, the flow F2 is an external flow and the flows F7, F8, and F9 are internal flows. In the sub-network N3, the flows F1 and F2 are external flows and the flows F10 and F11 are internal flows.

Parts surrounded by thick dotted lines are rows of only internal flows in the tables shown in FIGS. 36 to 38, respectively. These parts are subjected to the similar minimum-links estimation processing to that performed by the point-of-partial-quality-degradation estimation unit S17 according to the third embodiment.

As a result of the estimation processing, links {L1-6, L1-17} are estimated as links of quality degradation in the sub-network N1. Links {L2-2, L2-4}, {L2-7, L2-4}, {L2-10, L2-4}, {L2-12, L2-10}, {L2-24, L2-10}, and {L2-19, L2-10} are estimated in the sub-network N2, and {L3-10} and {L3-7} are estimated in the sub-network N3.

A list of all the links included in the result of the estimation processing is output as the set of links of quality degradation.

Namely, the links {L1-6, L1-17} are output in the sub-network N1, {L2-2, L2-4, L2-7, L2-12, L2-24, L2-19, L2-10} are output in the sub-network N2, and {L3-10, L3-7} are output in the sub-network N3.

Next, the point-of-partial-quality-degradation estimation unit S17 decides the solved external flows and unsolved external flows.

Namely, in the sub-network N1, since the external flows F1 and F2 do not pass through any links in the set of links of quality degradations {L1-6, L1-17}, the external flows F1 and F2 are both unsolved external flows.

Namely, in the sub-network N2, since the external flow F2 passes through the link L2-24 included in the set of links of quality degradation {L2-2, L2-4, L2-7, L2-12, L2-24, L2-19, L2-10}, the flow F2 is a solved external flow.

Namely, in the sub-network N3, since the external flow F1 passes through the link L3-10 included in the set of links of quality degradation {L3-10, L3-7}, the flow F1 is a solved external flow. Since the external flow F2 does not pass through any links included in the set of links of quality degradations {L3-10, L3-7}, the external flow F2 is an unsolved external flow.

The point-of-partial-quality-degradation estimation unit S17 notifies the server coordination unit S15 of the set of links of quality degradation obtained as stated above and the flow identifiers of the solved external flows and the information on rows of the unsolved external flows (information on flow identifiers, routing links, PrevNet, NextNet, quality flags).

The server coordination unit S15 notifies the entire network estimation server SA1 of these pieces of information.

The server coordination unit SA11 of the entire network estimation server SA1 notifies the point-of-quality-degradation estimation unit SA14 of the sets of links of quality degradation {L1-6, L1-17}, {L2-2, L2-4, L2-7, L2-12, L2-24, L2-19, L2-10}, and {L3-10, L3-7} notified by the sub-network point-of-quality-degradation estimation servers S1 to S3 in the respective sub-networks N1 to N3.

Further, the server coordination unit SA11 transmits the flow identifiers of solved external flows and the information on rows of unsolved external flows notified by the sub-network point-of-quality-degradation estimation servers S1 to S3 to the table processing unit SA12.

The table processing unit SA12 performs the following processing.

Since the information transmitted from the respective sub-network point-of-quality-degradation estimation servers S1 to S3 does not include the information indicating that the re-estimation processing has been performed, the table processing unit SA12 stores therein the identifiers of the solved external flows and the information on rows of unsolved external flows in the respective sub-networks N1 to N3 received from the server coordination unit SA12 as the processing performed if the transmitted information does not include the information indicating that the re-estimation processing has been performed.

It is to be noted that both the flows F1 and F2 are unsolved external flows at least in one or more of the sub-networks N1 to N3 and solved external flows at least in one or more of the sub-networks N1 to N3.

Therefore, the re-estimation unit S18 of the sub-network notified that these external flow identifiers (F1 and F2) are external flows is notified of the identifiers of the relevant external flows and an estimation instruction.

Namely, the flow F1 is an unsolved external flow in the sub-network N1 and a solved external flow in the sub-network N3. Due to this, the re-estimation unit S18 of the sub-network N3 is notified of the flow identifier of the external flow and the re-estimation instruction. Further, the flow F2 is an unsolved external flow in the sub-networks N1 and N3 and a solved external flow in the sub-network N2. Due to this, the re-estimation unit S18 of the sub-network N2 is notified of the flow identifier of the external flow and the re-estimation instruction.

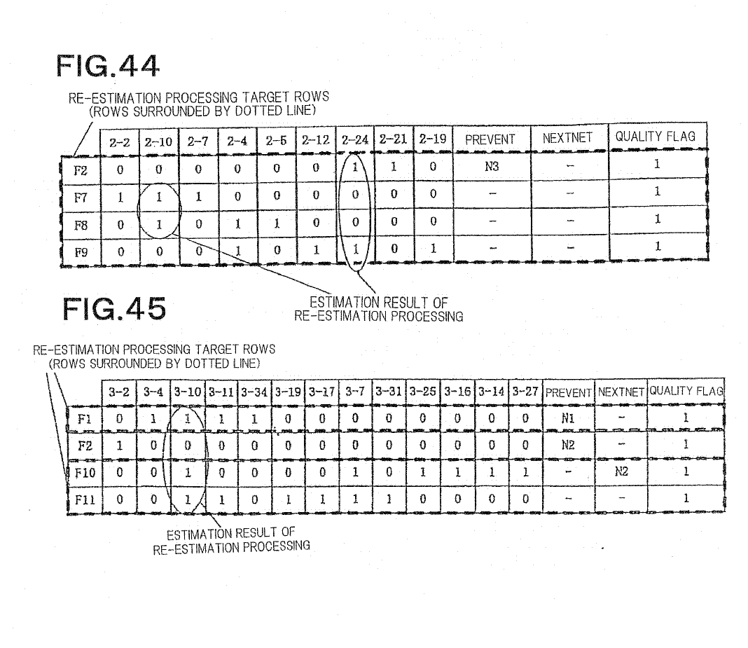

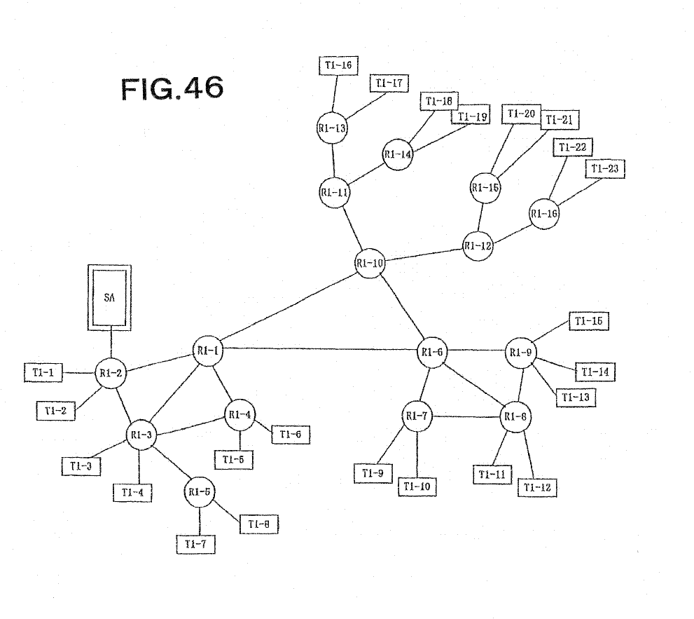

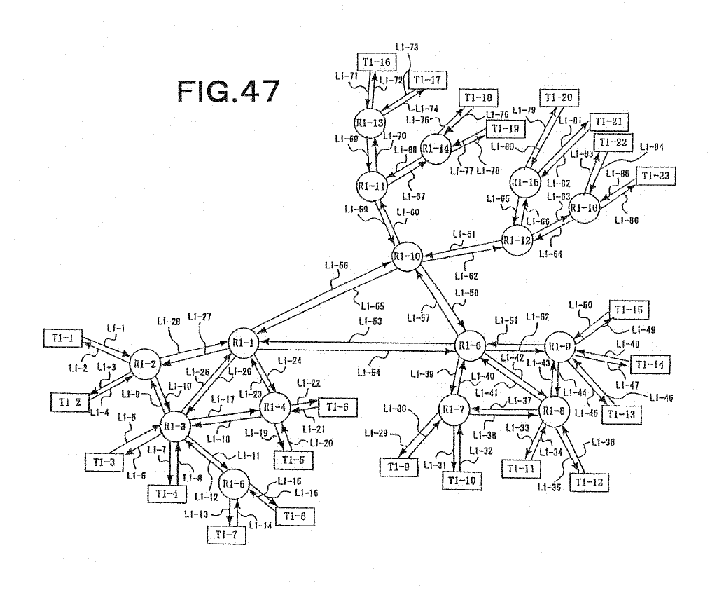

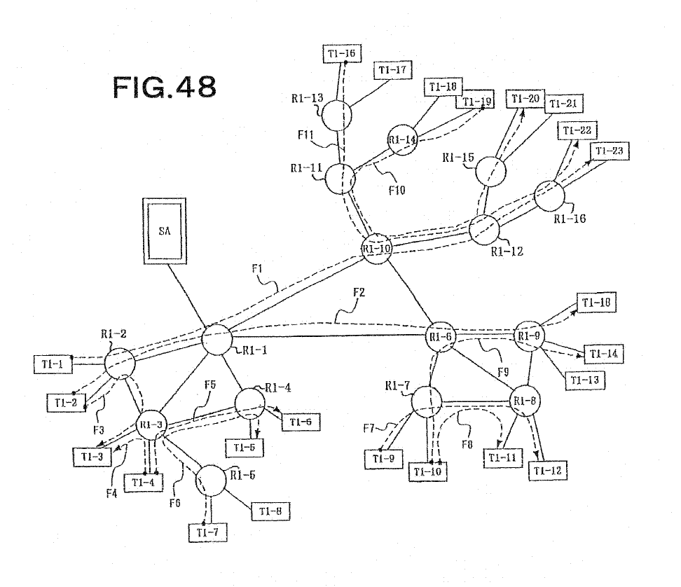

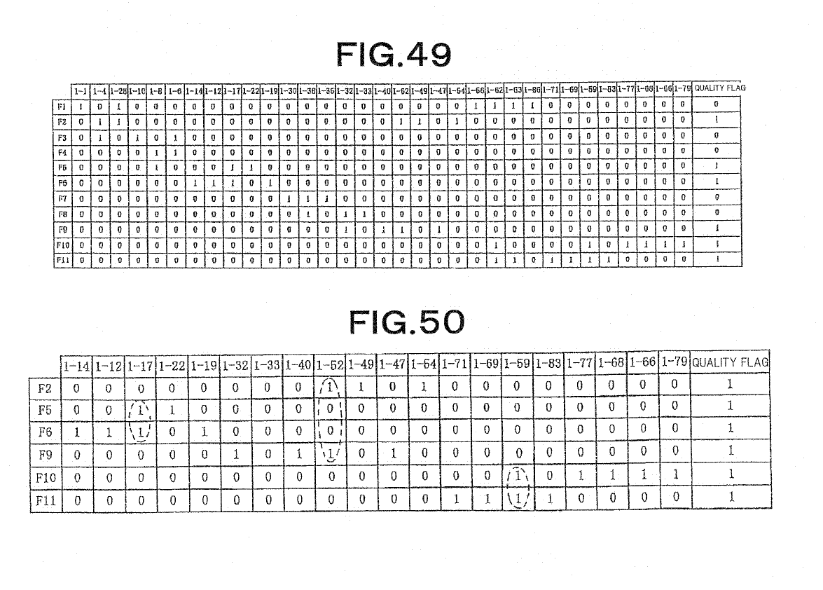

FIG. 44 is a diagram explaining the re-estimation processing in the sub-network N2.

The re-estimation unit S18 of the sub-network point-of-quality-degradation estimation server S2 in the sub-network N2 performs the minimum-links estimation processing on rows surrounded by a dotted line in FIG. 44 (rows of flows F2, F7, F8, and F9).

As a result of this processing, the re-estimation unit S18 of the sub-network point-of-quality-degradation estimation server S2 in the sub-network N2 obtains {L2-10, L2-24} as an estimation result.

The re-estimation unit S18 notifies the entire network point-of-quality-degradation estimation server SA1 of the flows {L2-10, L2-24} obtained as the estimation result, information that the flow F2 is a solved external flow in the sub-network N2, and information indicating that the re-estimation processing has been performed via the server coordination unit S16.

FIG. 45 is a diagram explaining the re-estimation processing in the sub-network N3.

The re-estimation unit S18 of the sub-network point-of-quality-degradation estimation server S3 in the sub-network N3 performs the minimum-links estimation processing on rows surrounded by a dotted line in FIG. 45 (rows of flows F1, F10, and F11).

As a result of this processing, the re-estimation unit S18 of the sub-network point-of-quality-degradation estimation server S3 in the sub-network N3 obtains {L3-10} as an estimation result. Accordingly, the fourth embodiment differs from the third embodiment in that the flow {L3-7} is removed by the re-estimation processing.

It is to be noted that the flow F1 is a solved external flow and the flow F2 is an unsolved external flow in the sub-network N3.

The re-estimation unit S18 notifies the entire network point-of-quality-degradation estimation server SA1 of the flow {L3-10} obtained as the estimation result, row information that the flow F1 is a solved external flow and the flow F2 is an unsolved external flow in the sub-network N3, and information indicating that the re-estimation processing has been performed via the server coordination unit S16.

The entire network point-of-quality-degradation estimation server SA1 performs a point-of-quality-degradation estimation processing as follows for the sub-networks N2 and N3 on which the re-estimation processing has been performed based on information after the re-estimation processing, and for the sub-network N1 on which the re-estimation processing has not been performed.

First, the server coordination unit SA11 notifies the point-of-quality-degradation estimation unit SA14 of the flows {L2-10, L2-24} and {L3-10} that are results of the re-estimation processings performed on the sub-networks N2 and N3.

Moreover, the server coordination unit SA11 notifies the table processing unit SA12 that the flow F2 is a solved external flow in the sub-network N2, the flow F1 is a solved external flow and the flow F2 is an unsolved external flow in the sub-network N3, information on rows of the flows, and the information indicating that the re-estimation processing has been performed.

The table processing unit SA12 performs the processing for the instance in which the transmitted information includes the information indicating that the re-estimation processing has been performed. Therefore, the table processing unit SA12 overwrites information on the stored information.

The flow F1 is an unsolved external flow in the sub-network N1 and a solved external flow in the sub-network N3, and the flow F2 is a solved external flow in the sub-network N2 and an unsolved external flow in the sub-network N3. Therefore, the external flows F1 and F2 both correspond to flows satisfying the condition (2) that the flow is an unsolved external flow at least in one or more of the sub-networks N1 to N3 and a solved external flow at least in one or more of the sub-networks N1 to N3.

Due to this, the table processing unit SA12 does not perform the merging processing for the flows F1 and F2.

The point-of-quality-degradation estimation unit SA14 does not perform the minimum-links estimation processing because of lack of the merging-processed table. Further, the display unit SA15 is notified of the sum of sets {L1-6, L1-17, L2-10, L2-24, L3-10} of links of quality degradation notified by the server coordination unit SA11 ({L1-17} notified from the sub-network N1, {N2-10, N2-24} notified from the sub-network N2 after the re-estimation processing, and {L3-10} notified from the sub-network N3 after the re-estimation processing) as the final result.

FIG. 39 shows the flow quality-to-routing link table after collecting flow information on the entire network and performing the non-degradation link removal processing according to the conventional method.

In this case, the result of the minimum-links estimation processing is {L1-6, L1-17, L2-10, L2-24, L3-10}.

The estimation result according to the fourth embodiment is {L1-6, L1-17, L2-10, L2-24, L3-10}. Thus, differently from the estimation result according to the third embodiment, the estimation result according to the fourth embodiment is identical with those according to the conventional method.

(Advantages of the Fourth Embodiment)

According to the fourth embodiment, it is possible to not only attain the advantages of the first embodiment but also maintain accuracy for estimating points of quality degradation without greatly increasing processing time required for the processing of estimating points of quality degradation since the re-estimation units S18 of the respective sub-networks N1 to N3 partially perform the re-estimation processing in parallel.

1-43. (canceled)

44. A network system collecting quality information and flow routing information on a network, comprising:
means for extracting flows each passing through a route of quality degradation based on quality information and routing information on flows each passing through one of a plurality of sub-networks constituting the network collected for each of the sub-networks constituting the network; and
means for estimating routes of quality degradation on the network by merging the quality information on the extracted flows on the respective sub-networks with one another on the entire network.

45. The network system according to claim 44,
wherein a route is defined as a route of no quality degradation even if a flow of quality degradation passes through the route as long as a flow of no quality degradation passes through the route.

46. The network system according to claim 44,
wherein the quality information is merged on the entire network according to each of the flows identified based on the routing information.

47. The network system according to claim 44,
wherein a route is defined as a route of no quality degradation even if a flow of quality degradation passes through the route as long as a flow of no quality degradation passes through the route,
internal flows each passing through only one of the sub-networks and external flows each passing through the plurality of sub-networks are extracted from the flows each passing through the route of quality degradation,
a sum of a set of routes estimated as routes of quality degradation for non-common internal flows that are included in the internal flows and that do not share routes with the external flows and the internal flows sharing at least one route with the external flows, and a set of routes estimated as the routes of quality degradation based on internal flows other than the non-common internal flows included in the internal flows and on the external flows are estimated as the routes of quality degradation on the network.

48. The network system according to claim 47,
wherein the routes are estimated as the routes of quality degradation by merging quality information on the internal flows other than the non-common internal flows included in the internal flows with quality information on the external flows according to the flows identified based on the routing information.

49. The network system according to claim 48,
wherein the routes estimated as the routes of quality degradation for the non-common internal flows are estimated as the routes of quality degradation in each of the sub-networks.

50. The network system according to claim 44,
wherein a route is defined as a route of no quality degradation even if a flow of quality degradation passes through the route as long as a flow of no quality degradation passes through the route,
internal flows each passing through only one of the sub-networks are extracted from the flows each passing through the route of quality degradation,
a first route of quality degradation is estimated for the internal flows,
external flows each passing through the route of quality degradation and not passing through the first route on each of the sub-networks through which each of the external flows passes are extracted from the external flows each passing through the plurality of sub-networks,
the quality information on the external flows is merged on the entire network for each of the flows identified based on the routing information,
a second route of quality degradation is estimated for the external flows based on the quality information on the merging-processed external flows, and
the route of quality degradation on the network is estimated by a sum of sets of the first route and the second route.

51. The network system according to claim 44,
wherein a route is defined as a route of no quality degradation even if a flow of quality degradation passes through the route as long as a flow of no quality degradation passes through the route,
internal flows each passing through only one of the sub-networks are extracted from the flows each passing through the route of quality degradation,
a first route of quality degradation is estimated for the internal flows,
a first external flow passing through the route of quality degradation and not passing through the first route on each of the sub-networks through which each of the external flows passes is extracted from the external flows each passing through the plurality of sub-networks,
the quality information on the first external flows is merged on the entire network for each of the flows identified based on the routing information,
a second route of quality degradation is estimated for the first external flows based on the quality information on the first merging-processed external flows,
a second external flow passing through the route of quality degradation and passing through at least the first route on each of the sub-networks through which each of the external flows passes through is extracted from the external flows each passing through the plurality of sub-networks,
a third route of quality degradation is estimated based on information on the second external flows and information on the internal flows on one of the sub-networks including the second external flow for the external flows including the first external flow and the second external flow on different sub-networks, and
the route of quality degradation on the network is estimated by a sum of sets of the first route, the second route, and the third route.

52. The network system according to claim 51,
wherein information indicating that a re-estimation is performed is added to the third route, and
if the third route and one of at least the first route and the second route are present on same sub-network, a higher priority is given to the information on the third route than the information on the first route or the second route.

53. A server of a network system collecting flow quality information and routing information on the network, the server provided to correspond to each of a plurality of sub-networks constituting the network, the server comprising:
means for extracting flows each passing through a route of quality degradation based on quality information and routing information on flows each passing through one of a plurality of sub-networks constituting the network collected for each of the sub-networks constituting the network; and
means for merging the quality information on the extracted flows on the respective sub-networks with one another on the entire network, thereby notifying a server on the network for estimating a route of quality degradation on the network of information on the extracted flows.

54. The server according to claim 53,
wherein a route is defined as a route of no quality degradation even if a flow of quality degradation passes through the route as long as a flow of no quality degradation passes through the route.

55. The server according to claim 53,
wherein the means for extracting the flows
creates an information table based on the quality information and the routing information collected for each of the sub-networks, and
extracts the flows each passing through the route of quality degradation by deleting, from the information table, information on flows of no quality degradation and information on flows estimated as the flows of no quality degradation while the route is defined as the route of no quality degradation even if a flow of quality degradation passes through the route as long as the flow of no quality degradation passes through the route.

56. The server according to claim 53,
wherein a route is defined as a route of no quality degradation even if a flow of quality degradation passes through the route as long as a flow of no quality degradation passes through the route,
internal flows each passing through only one of the sub-networks and external flows each passing through the plurality of sub-networks are extracted from the flows each passing through the route of quality degradation,
routes of quality degradation are estimated for non-common internal flows that are included in the internal flows and that do not share routes with the external flows and the internal flows sharing at least one route with the external flows, and
a sum of a set of the routes estimated as the routes of quality degradation and a set of routes estimated as the routes of quality degradation based on internal flows other than the non-common internal flows included in the internal flows and on the external flows are transmitted to a server on the network estimated as the server of quality degradation on the network for the non-common internal flows that are included in the internal flows and that do not share routes with the external flows and the internal flows sharing at least one route with the external flows.

57. The server according to claim 53,
wherein a route is defined as a route of no quality degradation even if a flow of quality degradation passes through the route as long as a flow of no quality degradation passes through the route,
the route of quality degradation is estimated for each of internal flows each passing through only one of the sub-networks and flows each passing through the plurality of sub-networks among the flows each passing through the route of quality degradation, and
the quality information on the flows each passing through the plurality of sub-networks is merged for the flows identified based on the routing information, and information on each of the estimated routes is transmitted to a server on the network on which a sum of a set of routes estimated as the routes of quality degradation for each of the internal flows and a set of routes estimated as the routes of quality degradation for the flows passing through the plurality of sub-networks is estimated as the routes of quality degradation on the network.

58. The server according to claim 53,
wherein a route is defined as a route of no quality degradation even if a flow of quality degradation passes through the route as long as a flow of no quality degradation passes through the route,
a first route of quality degradation is estimated for the internal flows each passing through only one of the sub-networks among the flows each passing through the route of quality degradation, and a first external flow passing through the route of quality degradation and not passing through the first route and a second external flow passing through the route of quality degradation and passing through the first route are extracted from external flows each passing through the route of quality degradation,
external flows each passing through the route of quality degradation and not passing through the first route of each of all the sub-networks through which each of the external flows passes, the quality information on the external flows is merged on the entire network for the flows identified based on the routing information, a second route of quality degradation is estimated for the external flows based on the merged quality information on the external flows, and information on the first route and information on the first external flow and the second external flow are transmitted to a server on the network on which the routes are estimated as the routes of quality degradation on the network by a sum of sets of the first route and the second route.

59. The server according to claim 58,
wherein, if the server on the network receives a third route of quality degradation estimated based on the second external flow and the information on the internal flows on one of the sub-networks including the second external flow for the external flows including the first external flow and the second external flow on a different sub-network, and estimates the route of quality degradation on the network by a sum of sets of the first route, the second route, and the third route, then the third route of quality degradation is estimated based on the information on the first external flow, the second external flow, and the internal flows, and the third route is transmitted to a server on the network in response to a request from a server on the network.

60. The server according to claim 59,
wherein, if the third route and one of at least the first route and the second route are present on same sub-network, a higher priority is given to the information on the third route than the information on the first route or the second route.

61. A server of a network collecting flow quality information and routing information on the network,
wherein the server receives information on flows each passing through a route of quality degradation extracted based on quality information and routing information on flows each passing through one of a plurality of sub-networks constituting the network from the plurality of sub-networks, and merges the quality information on the flows on the respective sub-networks with one another, thereby estimating routes of quality degradation on the network.

62. The server according to claim 61,
wherein the quality information on the flows each passing through the plurality of sub-networks is merged for each of the flows identified based on the routing information, and
a route is defined as a route of no quality degradation even if a flow of quality degradation passes through the route as long as a flow of no quality degradation passes through the route, and a sum of a set of routes estimated as the routes of quality degradation for internal flows each passing through only one of the sub-networks and a set of routes estimated as the routes of quality degradation for the flows each passing through the plurality of sub-networks is estimated as the routes of quality degradation on the network.

63. The server according to claim 61,
wherein a route is defined as a route of no quality degradation even if a flow of quality degradation passes through the route as long as a flow of no quality degradation passes through the route,
routes estimated as routes of quality degradation for internal flows each passing through only one of the sub-networks and external flows each passing through the plurality of sub-networks among the flows each passing through the route of quality degradation and for non-common internal flows that are included in the internal flows and that do not share routes with the external, flows and the internal flows sharing at least one route with the external flows are received,
a sum of a set of the received routes and the routes estimated as the routes of quality degradation based on internal flows other than the non-common internal flows that are included in the internal flows and on the external flows are estimated as the routes of quality degradation on the network.

64. The server according to claim 63,
wherein the routes are estimated as the routes of quality degradation by merging quality information on the internal flows other than the non-common internal flows included in the internal flows with quality information on the external flows for each of the flows identified based on the routing information.

65. The server according to claim 61,
wherein a route is defined as a route of no quality degradation even if a flow of quality degradation passes through the route as long as a flow of no quality degradation passes through the route,
a first route of quality degradation estimated for internal flows each passing through only one of the sub-networks are extracted from the flows each passing through the route of quality degradation is received,
external flows each passing through the route of quality degradation and not passing through the first route on each of the sub-networks through which each of the external flows passes are extracted from the external flows each passing through the plurality of sub-networks,
the quality information on the external flows is merged on the entire network for each of the flows identified based on the routing information,
a second route of quality degradation is estimated for the external flows based on the quality information on the merging-processed external flows, and
the route of quality degradation on the network is estimated by a sum of sets of the first route and the second route.

66. The server according to claim 61,
wherein a route is defined as a route of no quality degradation even if a flow of quality degradation passes through the route as long as a flow of no quality degradation passes through the route,
a first route of quality degradation estimated for internal flows each passing through only one of the sub-networks are extracted from the flows each passing through the route of quality degradation is received,
a first external flow passing through the route of quality degradation and not passing through the first route on each of the sub-networks through which each of the external flows passes is extracted from the external flows each passing through the plurality of sub-networks,
the quality information on the first external flows is merged on the entire network for each of the flows identified based on the routing information,
a second route of quality degradation is estimated for the first external flows based on the quality information on the merging-processed external flows,
a second external flow passing through the route of quality degradation and passing through at least the first route on each of the sub-networks through which each of the external flows passes through is extracted from the external flows each passing through the plurality of sub-networks,
a third route of quality degradation is received based on information on the second external flows and information on the internal flows on one of the sub-networks including the second external flow for the external flows including the first external flow and the second external flow on different sub-networks, and
the route of quality degradation on the network is estimated by a sum of sets of the first route, the second route, and the third route.

67. The server according to claim 66,
wherein information indicating that a re-estimation is performed is added to the third route, and
if the third route and one of at least the first route and the second route are present on same sub-network, a higher priority is given to the information on the third route than the information on the first route or the second route.

68. The server according to claim 66,
wherein the third route estimated as the route of quality degradation based on information on the second external flow and the internal flows is requested to one of the sub-networks including the second external flow for the external flow including the first external flow and the second external flow on the different networks.

69. The server according to claim 68,
wherein the third route is requested if information indicating that a re-estimation is performed is not added to the information on the route received from one of the sub-network for which the third route has been requested.

70. A point-of-quality-degradation estimation method of collecting flow quality information and routing information on a network and estimating a point of quality degradation, comprising steps of:
extracting flows each passing through a route of quality degradation based on quality information and routing information on flows each passing through one of a plurality of sub-networks constituting the network collected for each of the sub-networks constituting the network; and
estimating routes of quality degradation on the network by merging the quality information on the extracted flows on the respective sub-networks with one another on the entire network.

71. The point-of-quality-degradation estimation method according to claim 70, comprising a step of merging the quality information on the entire network for each of the flows identified based on the routing information.

72. The point-of-quality-degradation estimation method according to claim 70,
wherein the step of extracting the flows includes steps of
creating an information table based on the quality information and the routing information collected for each of the sub-networks; and
extracting the flows each passing through the route of quality degradation by deleting information, from the information table, on flows of no quality degradation and information on flows estimated as the flows of no quality degradation while the route is defined as the route of no quality degradation even if a flow of quality degradation passes through the route as long as the flow of no quality degradation passes through the route.

73. The point-of-quality-degradation estimation method according to claim 70, comprising steps of:
defining a route as a route of no quality degradation even if a flow of quality degradation passes through the route as long as a flow of no quality degradation passes through the route;
extracting internal flows each passing through only one of the sub-networks and external flows each passing through the plurality of sub-networks from the flows each passing through the route of quality degradation; and
estimating a sum of a set of routes estimated as routes of quality degradation for non-common internal flows that are included in the internal flows and that do not share routes with the external flows and the internal flows sharing at least one route with the external flows, and a set of routes estimated as the routes of quality degradation based on internal flows other than the non-common internal flows included in the internal flows and on the external flows as the routes of quality degradation on the network.

74. The point-of-quality-degradation estimation method according to claim 73, comprising a step of
estimating the routes as the routes of quality degradation by merging quality information on the internal flows other than the non-common internal flows included in the internal flows with quality information on the external flows according to the flows identified based on the routing information.

75. The point-of-quality-degradation estimation method according to claim 73,
wherein the route estimated for the non-common internal flows is estimated on each of the sub-networks.

76. The point-of-quality-degradation estimation method according to claim 70, comprising steps of:
defining a route as a route of no quality degradation even if a flow of quality degradation passes through the route as long as a flow of no quality degradation passes through the route;
extracting internal flows each passing through only one of the sub-networks from the flows each passing through the route of quality degradation;
estimating a first route of quality degradation for the internal flows;
extracting external flows each passing through the route of quality degradation and not passing through the first route on each of the sub-networks through which each of the external flows passes from the external flows each passing through the plurality of sub-networks;
merging the quality information on the external flows on the entire network for each of the flows identified based on the routing information;
estimating a second route of quality degradation for the external flows based on the quality information on the merging-processed external flows; and
estimating the route of quality degradation on the network by a sum of sets of the first route and the second route.

77. The point-of-quality-degradation estimation method according to claim 70, comprising steps of:
defining a route as a route of no quality degradation even if a flow of quality degradation passes through the route as long as a flow of no quality degradation passes through the route;
extracting internal flows each passing through only one of the sub-networks from the flows each passing through the route of quality degradation;
estimating a first route of quality degradation for the internal flows;
extracting a first external flow passing through the route of quality degradation and not passing through the first route on each of the sub-networks through which each of the external flows passes from the external flows each passing through the plurality of sub-networks;
merging the quality information on the first external flows on the entire network for each of the flows identified based on the routing information;
estimating a second route of quality degradation for the first external flows based on the quality information on the merging-processed external flows;
extracting a second external flow passing through the route of quality degradation and passing through at least the first route on each of the sub-networks through which each of the external flows passes through from the external flows each passing through the plurality of sub-networks;
estimating a third route of quality degradation based on information on the second external flows and information on the internal flows on one of the sub-networks including the second external flow for the external flows including the first external flow and the second external flow on different sub-networks; and
estimating the route of quality degradation on the network by a sum of sets of the first route, the second route, and the third route.

78. The point-of-quality-degradation estimation method according to claim 77, comprising a step of
adding information indicating that a re-estimation is performed to the third route, and, if the third route and one of at least the first route and the second route are present on same sub-network, giving a higher priority to the information on the third route than the information on the first route or the second route.

79. A computer program product executed on a computer processing apparatus of a server on a network for collecting flow quality information and routing information on the network and for estimating a point of quality degradation,
wherein a server on each of a plurality of sub-networks constituting the network is caused to include a function of extracting flows each passing through a route of quality degradation based on quality information and routing information on flows each passing through one of a plurality of sub-networks constituting the network collected for each of the sub-networks constituting the network; and
an entire server collecting information from the server on each of all the sub-networks is caused to include a function of estimating routes of quality degradation on the network by merging the quality information on the extracted flows on the respective sub-networks with one another on the entire network.

80. The computer program product according to claim 79,
wherein the entire server is caused to include a function of merging the quality information on the entire network for each of the flows identified based on the routing information.

81. The computer program product according to claim 79,
wherein the server on each of the sub-networks is caused to include
a function of defining a route as a route of no quality degradation even if a flow of quality degradation passes through the route as long as a flow of no quality degradation passes through the route;
a function of extracting internal flows each passing through only one of the sub-networks and external flows each passing through the plurality of sub-networks from the flows each passing through the route of quality degradation; and
a function of estimating first routes of quality degradation for non-common internal flows that are included in the internal flows and that do not share routes with the external flows and the internal flows sharing at least one route with the external flows, and
the entire server is caused to include a function of estimating a sum of a set of the first routes and a set of second routes estimated as the routes of quality degradation for based on internal flows other than the non-common internal flows included in the internal flows and on the external flows, as the routes of quality degradation on the network.

82. The computer program product according to claim 81,
wherein the routes is estimated as the routes of quality degradation by merging quality information on the internal flows other than the non-common internal flows included in the internal flows with quality information on the external flows according to the flows identified based on the routing information.

83. The computer program product according to claim 81,
wherein the server on each of the sub-networks is caused to include a function of estimating the route of quality degradation for the non-common internal flows on each of the sub-networks.

84. The computer program product according to claim 79,
wherein the server on each of the sub-networks is caused to include
a function of defining a route as a route of no quality degradation even if a flow of quality degradation passes through the route as long as a flow of no quality degradation passes through the route, and of extracting internal flows each passing through only one of the sub-networks from the flows each passing through the route of quality degradation;
a function of estimating a first route of quality degradation for the internal flows;
a function of extracting external flows each passing through the route of quality degradation and not passing through the first route on each of the sub-networks through which each of the external flows passes from the external flows each passing through the plurality of sub-networks, and
the entire server is caused to include
a function of merging the quality information on the external flows on the entire network for each of the flows identified based on the routing information;
a function of estimating a second route of quality degradation for the external flows based on the quality information on the merging-processed external flows; and
a function of estimating the route of quality degradation on the network by a sum of sets of the first route and the second route.

85. The computer program product according to claim 79,
wherein the server on each of the sub-networks is caused to include
a function of defining a route as a route of no quality degradation even if a flow of quality degradation passes through the route as long as a flow of no quality degradation passes through the route, and of extracting internal flows each passing through only one of the sub-networks from the flows each passing through the route of quality degradation;
a function of estimating a first route of quality degradation for the internal flows; and
a function of extracting a first external flow passing through the route of quality degradation and not passing through the first route on each of the sub-networks through which each of the external flows passes from the external flows each passing through the plurality of sub-networks,
the entire server is caused to include
a function of merging the quality information on the first external flows on the entire network for each of the flows identified based on the routing information; and
a function of estimating a second route of quality degradation for the first external flows based on the quality information on the merging-processed external flows,
the server on each of the sub-networks is caused to include
a function of extracting a second external flow passing through the route of quality degradation and passing through at least the first route on each of the sub-networks through which each of the external flows passes through from the external flows each passing through the plurality of sub-networks; and
a function of estimating a third route of quality degradation based on information on the second external flows and information on the internal flows on one of the sub-networks including the second external flow for the external flows including the first external flow and the second external flow on different sub-networks, and
the entire server is caused to include a function of estimating the route of quality degradation on the network by a sum of sets of the first route, the second route, and the third route.

86. The computer program product according to claim 85,
wherein the server on each of the sub-networks is caused to include a function of adding information indicating that a re-estimation is performed to the third route, and
the entire server is caused to include a function of, if the third route and one of at least the first route and the second route are present on same sub-network, giving a higher priority to the information on the third route than the information on the first route or the second route.
